(19) United States
(12) Patent Application Publication
(10) Pub. No.: US 2007/0190978 A1
(43) Pub. Date: Aug. 16, 2007

(54) System and Methodology for Extending Enterprise Messaging Systems to Mobile Devices

(75) Inventors: Shannon R. White, Waterloo (CA); Geno Coschi, Waterloo (CA); Andrew J. Quick, Kitchener (CA)

Correspondence Address: JOHN A. SMART, 708 BLOSSOM HILL RD., #201, LOS GATOS, CA, 95032-3503, US

(73) Assignee: iAnywhere Solutions, Inc., Dublin, CA (US)

(21) Appl. No.: 10/906,065

(22) Filed: Feb. 1, 2005

Related U.S. Application Data
(60) Provisional application No. 60/593,440, filed on Jan. 13, 2005.

(51) Int. Cl. H04L 12/58

(52) U.S. Cl. 455/412.1

(57) ABSTRACT

A system and methodology for extending enterprise messaging systems to mobile devices is described. In one embodiment, for example, a system for messaging between applications is described that comprises: a database at a mobile device for receiving a message from an application at the mobile device for transmission to a particular application at another device; an agent at the mobile device for sending the message to a server by synchronizing the database at the mobile device with a consolidated database at the server; a consolidated database at the server for storing the message received from the mobile device; and a module at the server for providing the message to the particular application.

### CROSS REFERENCE TO RELATED APPLICATIONS

The present application is related to and claims the benefit of priority of the following commonly-owned, presently-pending provisional application(s): application Ser. No. 60/593,440 (Docket No. IAS/0002.00), filed Jan. 13, 2005, entitled “System and Methodology for Extending Enterprise Messaging Systems to Mobile Devices”, of which the present application is a non-provisional application thereof. The disclosure of the foregoing application is hereby incorporated by reference in its entirety, including any appendices or attachments thereof, for all purposes.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### APPENDIX DATA

Computer Program Listing Appendix under Sec. 1.52(e): This application includes a transmittal under 37 C.F.R. Sec. 1.52(e) of a Computer Program Listing Appendix. The Appendix, which comprises text file(s) that are IBM-PC machine and Microsoft Windows Operating System compatible, includes the below-listed file(s). All of the material disclosed in the Computer Program Listing Appendix can be found at the U.S. Patent and Trademark Office archives and is hereby incorporated by reference into the present application.

Object Description: SourceCode.txt, size: 50010 Bytes, created: Jan. 13, 2005 3:04:36 PM; Object ID: File No. 1; Object Contents: Source code.

### BACKGROUND OF INVENTION

1. Field of the Invention

The present invention relates generally to data processing environments and, more particularly, to a system providing methodology for extending enterprise messaging systems to mobile devices.

2. Description of the Background Art

Computers are very powerful tools for storing and providing access to vast amounts of information. Computer databases are a common mechanism for storing information on computer systems while providing easy access to users. A typical database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details. Typically, all requests from users for access to the data are processed by the DBMS. For example, information may be added or removed from data files, information retrieved from or updated in such files, and so forth, all without user knowledge of the underlying system implementation. In this manner, the DBMS provides users with a conceptual view of the database that is removed from the hardware level. The general construction and operation of database management systems is well known in the art. See e.g., Date, C., “An Introduction to Database Systems, Seventh Edition”, Part I (especially Chapters 1-4), Addison Wesley, 2000.

Organizations are looking for solutions that enable them to extend enterprise applications (including database applications) and programs to provide services not only to users on a local LAN, but also to users of mobile devices which are occasionally connected to the enterprise. A business may, for example, equip its sales representatives working in offices around the world with mobile devices (e.g., laptop computers, notebook computers, “smart” phones, personal digital assistants (PDAs), or other portable devices). It is desirable to provide these sales representatives with access to the organization's data, systems, and applications so that the sales representatives may more efficiently perform their jobs and may coordinate their activities with others in the organization. In addition, it is desirable to facilitate the development and deployment of applications on mobile devices that can interact with applications residing on other devices (including other mobile devices). An application-to-application messaging solution supports interoperability among loosely coupled applications over a message passing infrastructure. A message is a string of bytes, containing data to be delivered from one application to another. A message generally includes a message header and application data. The nature of the application data that is included in the message is defined by the application. There is increasing user interest in application-to-application messaging solutions which permit communication between custom programs running on different devices, including mobile or wireless devices. There are, however, a number of challenges in extending enterprise systems and applications to mobile devices.

Today, there are a variety of mobile devices in use, ranging from PDAs (personal digital assistants) to laptop computers. These devices are used to run various types of application software. When one considers use of these devices on the road, the issue of connectivity arises. When a device is “connected” (e.g., in communication with a remote service or device), for example, consideration has to be given as to what type of network (e.g., wireless or wireline) is available for the device. Related to the type of network is the availability of that network: the user may or may not have connectivity to a particular network at a given instance in time. Another consideration for mobile devices is the existing enterprise messaging architecture that mobile devices integrate with. These include IBM's MQ Series (available from IBM Corporation of Armonk, N.Y.) and Java 2 Enterprise Edition (j2EE) application servers offered by various vendors. The existing architecture is important since it typically will be the source of messages going to devices, as well as the destination of messages coming from the devices.

Mobile personal digital assistants, notebooks, and other mobile devices typically have resource limitations and constraints that must also be considered in providing solutions in this environment. One limitation is that some mobile devices have fairly limited amounts of storage (e.g., hard disk) and memory (e.g., RAM) available. While laptop computers may include ample memory, PDA devices on the other hand typically do not. Therefore, when deploying application software in a mobile environment one should be cognizant of the fact that certain deployments must operate in a memory-constrained device. In a similar manner, many mobile devices may also have less processing power and shorter battery life compared to desktop or notebook computer systems. They may also have device specific operating systems which have smaller footprint, but also have somewhat more limited functionality. In addition, mobile devices frequently run on batteries, which may limit the amount of time that they can stay running.

Mobiles devices typically support one or more forms of communication with other computing platforms (e.g., through wireless network connections and/or wireline network connections). The particular communication mechanism used by a mobile device may change from time to time as the device is moved from place to place. If a wireless network is used for connecting to enterprise systems, communications between the mobile device and enterprise systems can be problematic, due to spotty connectivity/reliability that is unfortunately the current state-of-the-art. Therefore, one must contend with an environment in which connectivity may be up one minute but yet down the next, with the pattern repeating in a random fashion.

It is a challenge to provide for efficient application-to-application communication between programs (e.g., applications) running on mobile devices and enterprise systems in this type of environment. There is a need for facilitating communication between the mobile device and the enterprise (e.g., a centrally located server application) and between the mobile device and applications on other occasionally-connected mobile devices. Messaging is a useful communication mechanism that can be utilized for providing communication in occasionally-connected environments. However, an application to application messages solution in this types of environment needs to ensure that message can be sent by one mobile device and received by another mobile device even though the two devices do not directly communicate with each other and may not connect to a network or be in operation at the same time.

Given the above shortcomings in the available deployment environments, it is also desirable to be able to specify what messages should be included in any message transmission that actually occurs. For example, if one needs to send a large message (e.g., several megabyte transmission) on a network that is unreliable, one ideally would elect to not send the entire message at once (since it is unlikely that it will reach its destination). Instead, one would prefer to attempt the transfer of large messages when network reliability improves. Therefore, it is desirable to be able to define and apply rules for transmitting messages which specify what messages are to be transmitted at particular times and in particular circumstances (i.e., “what to go” and “when to go”), thereby improving message delivery.

What is needed is an application-to-application messaging solution that enables messages to be constructed even when the destination application is not reachable over the network. This would enable messages to be exchanged even though the sender application and the recipient application are not connected to the network, or even running, at the same time. The solution should also handle the challenges of wireless networks, such as slow speed, spotty geographic coverage, and dropped network connections. It should also enable users to specify what types of messages should transmitted in particular circumstances, thereby providing for greater efficiency in message delivery. The present invention provides a solution for these and other needs.

### SUMMARY OF INVENTION

A system and methodology for extending enterprise messaging systems to mobile devices is described. In one embodiment, for example, a system of the present invention for messaging between applications is described that comprises: a database at a mobile device for receiving a message from an application at the mobile device for transmission to a particular application at another device; an agent at the mobile device for sending the message to a server by synchronizing the database at the mobile device with a consolidated database at the server; a consolidated database at the server for storing the message received from the mobile device; and a module at the server for providing the message to the particular application.

In another embodiment, for example, a method of the present invention is described for messaging between applications where at least some of the applications are running on mobile devices, the method comprises steps of: receiving a message from an application at a mobile device for transmission to a particular application at another device; storing the message in a database at the mobile device; synchronizing the database at the mobile device with a consolidated database at a server when the mobile device establishes connectivity with the server, so as to transmit the message from the mobile device to the server; and providing the message in the consolidated database at the server to the particular application.

In yet another embodiment, for example, in a messaging system comprises a plurality of devices exchanging messages, a method of the present invention is described for regulating message transmission based on specified rules, the method comprises steps of: receiving rules specifying when messages are to be transmitted by at least some of the plurality of devices; determining whether transmission of a message received at a particular device for transmission to another device is permitted under the rules; transmitting the message if transmission is permitted under the rules; and otherwise, delaying transmission of the message until transmission of the message is permitted under the rules.

### BRIEF DESCRIPTION OF DRAWINGS

FIG. 1 is a very general block diagram of a computer system (e.g., an IBM-compatible system) in which software-implemented processes of the present invention may be embodied.

FIG. 2 illustrates the general structure of a client/server database system suitable for implementing the present invention.

FIG. 3 is a high-level block diagram of an environment in which the the QAnywhere messaging system of the present invention may be preferably implemented.

FIG. 4 is a flow diagram illustrating the sequence of interactions as the message flows from the sending QAnywhere application to the server message store (consolidated database).

FIG. 5 is a flow diagram illustrating the sequence of interactions as the message flows from the consolidated database on the server (i.e., server message store) to a receiving QAnywhere application.

FIGS. 6A-B comprise a single high-level flowchart illustrating the process of synchronization of a client database with a server-side consolidated database.

### DETAILED DESCRIPTION

Glossary

The following definitions are offered for purposes of illustration, not limitation, in order to assist with understanding the discussion that follows.

Message: A message is an object with structure that is transmitted by a sender for delivery over a network to a recipient. A message generally has defined headers, properties, and content. The content may be binary (a byte stream) or text (Unicode or ASCII, depending on the platform). The system and methodology of the present invention provides for a message from an application at a device to be placed on a queue for delivery over a network to another queue at another device.

Message store: A message store is a persistent store for messages. In the currently preferred embodiment of the present invention, a relational database serves as the message store for storing messages at the central server(s) and at remote clients (i.e., mobile devices).

Network status notification: A network status notification is a notification sent by a MobiLink Listener (on a client) to the QAnywhere Agent (also on the client) when a change in network status is detected. Currently, the following changes in network status are detected: network connected, network disconnected, and network address (e.g., IP address) change.

Policy: In this document, the term “policy” refers to a predefined set of rules for transmitting/receiving messages (e.g., on a mobile device or a server). Standard transmission policies which are provided in the currently preferred embodiment of the present invention include “scheduled”, “automatic”, and “ondemand” policies. With a “scheduled” policy, message transfers are done at regular, specified time intervals. With an “automatic” policy, the QAnywhere messaging system attempts to perform message transmissions exactly when needed. With an “ondemand” policy, the messaging system leaves it to the messaging application to control when message transfers are performed. Users may also provide a custom policy for message delivery by creating transmission rules as described herein.

Push notification: A push notification is a notification sent by the QAnywhere Notifier (on the server) to a MobiLink Listener (on a mobile client) when it detects that a message is destined for a message store on that mobile client. In the currently preferred embodiment of the present invention, a push notification can be either a UDP message or an SMS message. In the former case, the mobile device should be connected to an IP network in order to receive it. In the latter case, the mobile device should be capable of receiving an SMS message.

Relational database: A relational database is a collection of data items organized as a set of formally-described tables from which data can be accessed or reassembled in many different ways without having to reorganize the database tables. The relational database was invented by E. F. Codd at IBM in 1970. A relational database employs a set of tables containing data fitted into predefined categories. Each table (which is sometimes called a relation) contains one or more data categories in columns. The standard user and application program interface to a relational database is the structured query language (SQL), defined below.

SQL: SQL stands for Structured Query Language. The original version called SEQUEL (structured English query language) was designed by IBM in the 1970's. SQL-92 (or SQL/92) is the formal standard for SQL as set out in a document published by the American National Standards Institute in 1992; see e.g., “Information Technology—Database languages—SQL”, published by the American National Standards Institute as American National Standard ANSI/ISO/IEC 9075: 1992, the disclosure of which is hereby incorporated by reference. SQL-92 was superseded by SQL-99 (or SQL3) in 1999; see e.g., “Information Technology—Database Languages—SQL, Parts 1-5” published by the American National Standards Institute as American National Standard INCITS/ISO/IEC 9075-(1-5)-1999 (formerly ANSI/ISO/IEC 9075-(1-5) 1999), the disclosure of which is hereby incorporated by reference.

Synchronization: Synchronization refers the process of data and/or message synchronization between a client and a server in which data and/or messages are downloaded (i.e., transmitted from the server to the client) and/or uploaded (i.e., transmitted from the client to the server). In the currently preferred embodiment of the present invention, a MobiLink data synchronization mechanism is used for synchronization of data and/or messages. The MobiLink synchronization system is available as a component of SQL Anywhere® Studio (available from iAnywhere Solutions, Inc. of Dublin, Calif.). MobiLink offers bidirectional exchange of information between remote databases (e.g., Adaptive Server® Anywhere or UltraLite databases available from iAnywhere Solutions, Inc.) and a variety of enterprise data sources including Adaptive Server® Anywhere, Sybase® Adaptive Server® Enterprise, Oracle, Microsoft SQL Server, IBM DB2, and other ODBC-compliant databases. Remote systems connect via standard Internet protocols such as TCP/IP, HTTP or HTTPS to the MobiLink synchronization server, which communicates with a back end (consolidated) database. MobiLink is a session-based synchronization system that allows two-way synchronization between a main database, called the consolidated database, and many remote databases. The consolidated database holds the master copy of all the data. Synchronization typically begins when a MobiLink remote site opens a connection to a MobiLink synchronization server. During synchronization, the MobiLink client at the remote site uploads database changes that were made to the remote database since the previous synchronization. On receiving this data, the MobiLink synchronization server updates the consolidated database, and then downloads changes on the consolidated database to the remote database.

Transmission Rule: An instruction for describing the conditions for transmitting or receiving messages. The present invention includes features enabling users to create transmission rules on the server to define which messages should be downloaded to the client, and transmission rules on the client to define which messages should be uploaded to the server. Transmission rules can also be defined to indicate when to delete messages from a message store. By default, messages are deleted from client message stores when the final status of the message is determined to be received or expired. A user can specify rules providing for messages to be deleted faster than this default rule, or to hold on to messages after acknowledgment by creating a “delete” section in a client transmission rules file.

Introduction

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

Computer-Based Implementation

Basic system hardware and software (e.g., for desktop and server computers)

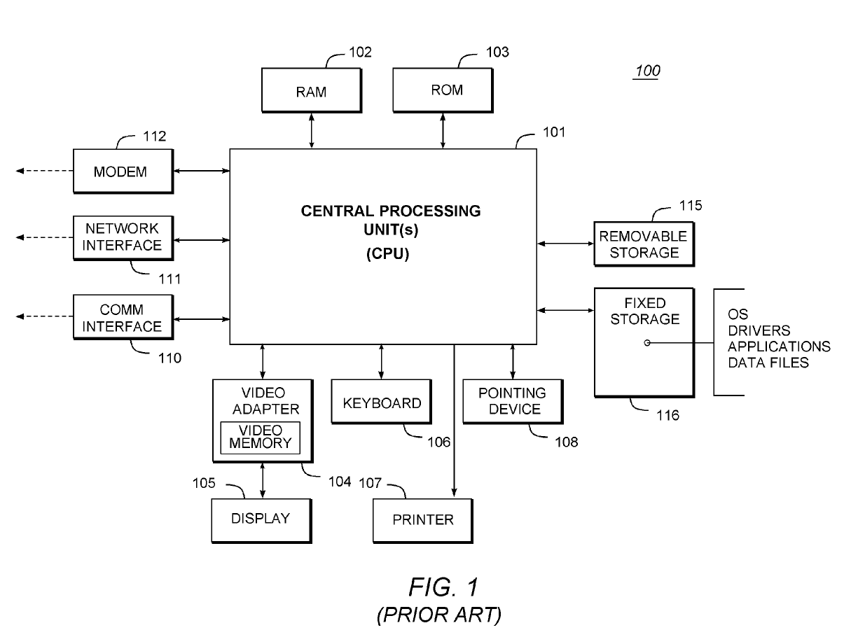

The present invention may be implemented on a conventional or general-purpose computer system, such as an IBM-compatible personal computer (PC) or server computer. FIG. 1is a very general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises a processor of the Intel Pentium family of microprocessors. However, any other suitable processor may be utilized for implementing the present invention. The CPU 101communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP Laserjet printer (available from Hewlett Packard of Palo Alto, Calif.), for creating hard copy images of output of the system.

The system itself communicates with other devices (e.g., other computers) via the network interface card (NIC) 111connected to a network (e.g., Ethernet network, Bluetooth wireless network, or the like), and/or modem 112 (e.g., 56 K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, such as Microsoft Windows 9×, Microsoft Windows NT, Microsoft Windows 2000, or Microsoft Windows XP (all available from Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

Client-Server Database Management System

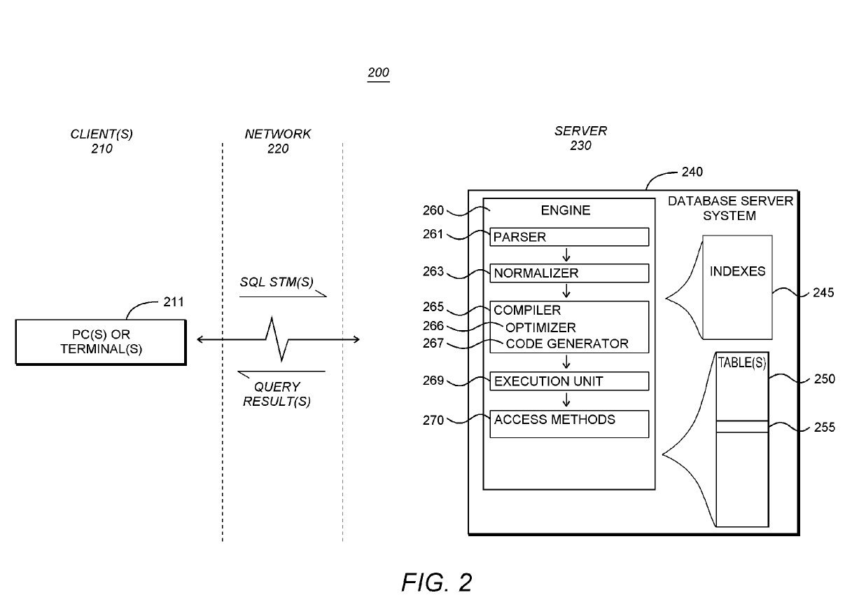

While the present invention may operate within a single (standalone) computer (e.g., system 100 of FIG. 1), the present invention is preferably embodied in a multi-user computer system, such as a client/server system. FIG. 2 illustrates the general structure of a client/server database system 200 suitable for implementing the present invention. As shown, the system 200 comprises one or more client(s) 210 connected to a server 230 via a network 220. Specifically, the client(s) 210 comprise one or more standalone terminals 211 connected to a database server system 240 using a conventional network. In an exemplary embodiment, the terminals 211 may themselves comprise a plurality of standalone workstations, dumb terminals, or the like, or comprise personal computers (PCs) such as the above-described system 100. Typically, such units would operate under a client operating system, such as a Microsoft® Windows client operating system (e.g., Microsoft® Windows 95/98, Windows 2000, or Windows XP).

The database server system 240, which comprises Sybase® Adaptive Server® Anywhere (available from Sybase, Inc. of Dublin, Calif.) in an exemplary embodiment, generally operates as an independent process (i.e., independently of the clients), running under a server operating system such as Microsoft® Windows NT, Windows 2000, or Windows XP (all from Microsoft Corporation of Redmond, Wash.), UNIX (Novell), Solaris (Sun), or Linux (Red Hat). The network 220 may be any one of a number of conventional network systems, including a Local Area Network (LAN) or Wide Area Network (WAN), as is known in the art (e.g., using Ethernet, IBM Token Ring, or the like). The network 220 includes functionality for packaging client calls in the well-known Structured Query Language (SQL) together with any parameter information into a format (of one or more packets) suitable for transmission to the database server system 240.

Client/server environments, database servers, and networks are well documented in the technical, trade, and patent literature. For a discussion of Sybasee-branded database servers and client/server environments generally, see, e.g., Nath, A., “The Guide to SQL Server”, Second Edition, Addison-Wesley Publishing Company, 1995. For a description of Sybase® Adaptive Server® Anywhere, see, e.g., “Adaptive Server Anywhere 9.0.1: Core Documentation Set,” available from Sybase, Inc. of Dublin, Calif. This product documentation is available via the Internet (e.g., currently at sybooks.sybase.com/aw.html). The disclosures of the foregoing are hereby incorporated by reference.

In operation, the client(s) 210 store data in, or retrieve data from, one or more database tables 250, as shown at FIG. 2. Data in a relational database is stored as a series of tables, also called relations. Typically resident on the server 230, each table itself comprises one or more “rows” or “records” (tuples) (e.g., row 255 as shown at FIG. 2). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number, and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of the Structured Query Language (SQL), which is a language allowing users and administrators to create, manipulate, and access data stored in the database. The syntax of SQL is well documented; see, e.g., the above-mentioned “An Introduction to Database Systems”. SQL statements may be divided into two categories: data manipulation language (DML), used to read and write data; and data definition language (DDL), used to describe data and maintain the database. DML statements are also called queries. In operation, for example, the clients 210 issue one or more SQL commands to the server 230. SQL commands may specify, for instance, a query for retrieving particular data (i.e., data records meeting the query condition) from the database table(s) 250. In addition to retrieving the data from database server table(s) 250, the clients 210 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 210 (via network 220) are processed by the engine 260 of the database server system 240. The engine 260 itself comprises a parser 261, a normalizer 263, a compiler 265, an execution unit 269, and an access methods 270. Specifically, the SQL statements are passed to the parser 261which converts the statements into a query tree—a binary tree data structure which represents the components of the query in a format selected for the convenience of the system. In this regard, the parser 261 employs conventional parsing methodology (e.g., recursive descent parsing).

The query tree is normalized by the normalizer 263. Normalization includes, for example, the elimination of redundant data. Additionally, the normalizer 263 performs error checking, such as confirming that table names and column names which appear in the query are valid (e.g., are available and belong together). Finally, the normalizer 263 can also look-up any referential integrity constraints which exist and add those to the query.

After normalization, the query tree is passed to the compiler 265, which includes an optimizer 266 and a code generator 267. The optimizer 266 is responsible for optimizing the query tree. The optimizer 266 performs a cost-based analysis for formulating a query execution plan. The optimizer will, for instance, select the join order of tables (e.g., when working with more than one table), and will select relevant indexes (e.g., when indexes are available). The optimizer, therefore, performs an analysis of the query and selects the best execution plan, which in turn results in particular access methods being invoked during query execution. It is possible that a given query may be answered by tens of thousands of access plans with widely varying cost characteristics. Therefore, the optimizer must efficiently select an access plan that is reasonably close to an optimal plan. The code generator 267 translates the query execution plan selected by the query optimizer 266 into executable form for execution by the execution unit 269 using the access methods 270.

All data in a typical relational database system is stored in pages on a secondary storage device, usually a hard disk. Typically, these pages may range in size from 1 Kb to 32 Kb, with the most common page sizes being 2 Kb and 4 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages that have been read from disk reside is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. This can be done by using data structures and algorithms that maximize the use of pages that are known to reside in the cache. Alternatively, it can be done by being more selective about what pages are loaded into the cache in the first place. An additional consideration with respect to I/O is whether it is sequential or random. Due to the construction of hard disks, sequential I/O is much faster then random access I/O. Data structures and algorithms encouraging the use of sequential I/O can realize greater performance.

For enhancing the storage, retrieval, and processing of data records, the server 230 maintains one or more database indexes 245 on the database tables 250. Indexes 245 can be created on columns or groups of columns in a table. Such an index allows the page containing rows that match a certain condition imposed on the index columns to be quickly located on disk, rather than requiring the engine to scan all pages in a table to find rows that fulfill some property, thus facilitating quick access to the data records of interest. Indexes are especially useful when satisfying equality and range predicates in queries (e.g., a column is greater than or equal to a value) and “order by” clauses (e.g., show all results in alphabetical order by a given column).

A database index allows the records of a table to be organized in many different ways, depending on a particular user's needs. An index key value is a data quantity composed of one or more fields from a record which are used to arrange (logically) the database file records by some desired order (index expression). Here, the column or columns on which an index is created form the key for that index. An index may be constructed as a single disk file storing index key values together with unique record numbers. The record numbers are unique pointers to the actual storage location of each record in the database file.

Indexes are usually implemented as multi-level tree structures, typically maintained as a B-Tree data structure. Pointers to rows are usually stored in the leaf nodes of the tree, so an index scan may entail reading several pages before reaching the row. In some cases, a leaf node may contain the data record itself. Depending on the data being indexed and the nature of the data being stored, a given key may or may not be intrinsically unique. A key that is not intrinsically unique can be made unique by appending a RID. This is done for all non-unique indexes to simplify the code for index access. The traversal of an index in search of a particular row is called a probe of the index. The traversal of an index in search of a group of rows fulfilling some condition is called a scan of the index. Index scans frequently look for rows fulfilling equality or inequality conditions; for example, an index scan would be used to find all rows that begin with the letter ‘A’.

The above-described computer hardware and software are presented for purposes of illustrating the basic underlying desktop and server computer components that may be employed for implementing the present invention. For purposes of discussion, the following description will present examples in which it will be assumed that there exists a “server” (e.g., database server or application server) that communicates with one or more “clients” (e.g., personal computers or mobile devices). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below. Overview of system and methodology for extending enterprise application to mobile devices

Messaging is a useful mechanism for providing communication between devices in occasionally-connected environments. One solution for supporting messaging between devices in this type of environment is to build a messaging system that uses the directory in the underlying file system (of the target device's operating system) as a message store. Here, a message would be encapsulated in a single file stored by the file system. In order to exchange messages between a given mobile device and a server, a proprietary protocol based on UDP may be employed. However, that approach has certain disadvantages. In particular, because the file system is being employed as the message store one forgoes capabilities that are available had one instead used a relational database as the message store. The robustness of storage available from relational databases that ensures that message data is properly stored is not available with typical operating system-based file systems. For example, transaction semantics may be used in relational databases systems to group a set of messages together so that either all messages are sent together/posted to a server or none are so posted. Use of UDP for message transmission is also problematic, especially for interfacing with enterprise messaging systems. UDP itself is not typically a protocol that is allowed to enter an enterprise. Enterprises typically employ firewalls that are configured to reject UDP packets.

The present invention provides an improved system and methodology for extending enterprise applications to mobile devices. It provides application-to-application messaging, including mobile device to mobile device messaging as well as mobile device messaging to and from the enterprise. The solution uses relational databases for storing messages on mobile devices and on the server, thereby improving reliability and taking advantages of the features and benefits provided by relational databases. It also uses data synchronization as the messaging protocol. The present invention leverages an existing technique for moving data from enterprises to mobile devices. In accordance with the present invention, a messaging system is built on top of a data synchronization system. Data synchronization itself entails a relational database on the server and one on the client, where the process of synchronization includes moving data from the relational database on the client to and from the relational database on the server. Data synchronization already includes general features that benefit messaging, including encryption. Additionally, data synchronization includes database-specific features that benefit messaging, including robustness of storage and database transaction semantics. Further, the existing protocol available for data synchronization may be used for messaging (instead of including a separate one, such as UDP-based one). Using existing data synchronization protocols solves the problem of getting information into and out of enterprises, and thus may be adapted for enterprise messaging use (thereby overcoming the previously mentioned difficulty with corporate firewalls). In this manner, the present invention is able to provide a novel messaging solution that leverages off of existing relational databases and data synchronization technique.

The present invention provides a comprehensive application-to-application messaging system and infrastructure for mobile users, enabling users to develop and deploy applications that exchange messages with remote applications located on a variety of devices (e.g., server systems and mobile devices running Windows, Windows CE, or other operating systems). The store-and-forward nature of the messaging solution provided by the present invention means that messages can be constructed even when the destination application is not reachable over the network; the message is delivered when the network becomes available. The system and methodology of the present invention provides for messages (sometimes referred to herein as “QAnywhere” messages) to be exchanged via a central server, so that the sender and recipient of a message never have to be connected to the network at the same time. Applications store messages in queues until a connection between the client and the server is available for message transmission. Applications use relational databases as a temporary message store. The relational database ensures that the message store has security, transaction-based computing, and the other benefits of relational databases. The use of a relational database as a message store also facilitates the use of the present invention in conjunction with a data synchronization solution, such as that available in SQL Anywhere® Studio. The present invention provides for extending this data synchronization mechanism to enable application-to-application messages to be exchanged between and among mobile devices and enterprise systems.

The present invention also provides network-independent communication. QAnywhere messages can be transported over TCP/IP, HTTP, or HTTPS protocols. They can also be delivered from a Windows CE handheld device by ActiveSync. The message itself is independent of the network protocol, and can be received by an application that communicates over a different network. The present invention also handles the challenges of wireless networks, such as slow speed, spotty geographic coverage, and dropped network connections. It protects proprietary or sensitive information by encrypting all messages sent over public networks. In its currently preferred embodiment, the system compresses and, optionally, encrypts data sent between mobile applications and enterprise servers.

The present invention also includes features enabling users to customize the delivery of messages using transmission rules so that, for example, messages are transmitted at the most convenient times. Users can create rules that specify when message transmission should occur, as well as customize the persistence of messages in the message stores. Transmission rules provide the ability to configure the messaging system to control what messages are sent and the timing of when to send them. The ability to control which messages can be sent during a transmission is important in an environment in which mobile devices are occasionally connected through different types of network connections (e.g. wireless and wireline), which have varying degrees of reliability and throughput (bandwidth). Transmission rules provide the ability to configure the messaging system so that a user can specify when messages are to be transmitted depending upon, for example, the type of network connectivity that is available from time to time. A user can, for instance, create a transmission which specifies sending high priority messages whenever connectivity is available, but reserves transmission of lower priority messages to “off hours” or when a better, more reliable connection is available.

In its currently preferred embodiment, the QAnywhere messaging system of the present invention includes a number of features and components that facilitate application-to-application communication. An object-oriented QAnywhere API provides an infrastructure for building messaging applications (e.g., for Windows desktop and Windows CE devices). Client applications send and receive messages using the QAnywhere programming API. Messages are queued in client message stores for exchange through a central QAnywhere server message store (referred to below as a “consolidated” database or data store). In addition to providing support for exchanging messages among QAnywhere applications, the solution also enables QAnywhere clients to be integrated into enterprise messaging systems (e.g., enterprise messaging systems which support aJMS interface). The present invention also includes support for multiple arbitrarily-named queues on client devices, permitting multiple client applications to coexist on a single device. Applications can send and receive messages on any number of queues. Messages can be sent between applications that are coexisting on the same device and between applications on different devices.

The present invention also includes features for server-initiated send and receive of messages are also provided. Messages can be pushed to client devices, allowing client applications to implement message-driven logic. The system has the ability to detect when messages are available/staged on the server available for delivery to the client. This includes notifying a client that there are messages (and/or data) at the server available for synchronizing down to the client. This notification may cause the client to initiate a synchronization session with the server. The present invention also includes support for “resumable” downloads providing for transmitting large messages or groups of messages to clients in a piecemeal fashion so as to minimize the retransmission of data during network failures.

A device tracking feature is also provided by the present invention for detecting when a client device goes in and out of coverage (i.e., establishes and loses network connectivity). When a client device comes into coverage (e.g., establishes connectivity) that is a good indicator that the client should check and see if there are any messages waiting at the server. For example, as a mobile device moves on the road (e.g., traveling to a remote location), it may lose connectivity to a wireless network. When connectivity is reestablished, this is an indicator that the mobile device should check to see if there is any data to be synchronized.

System Components

Client and Server Components

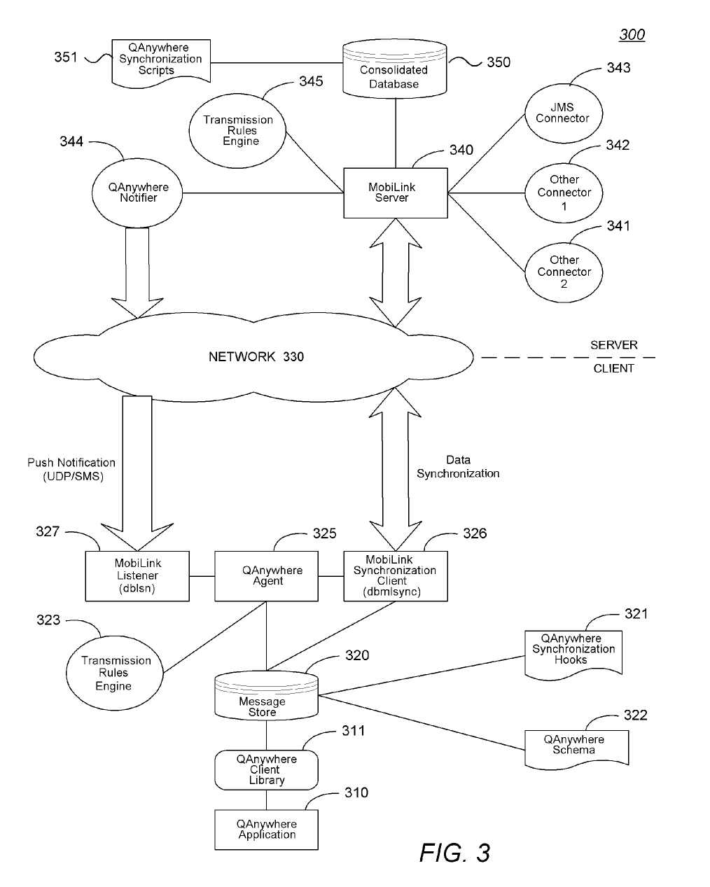

FIG. 3 is a high-level block diagram of an environment 300 in which the the QAnywhere messaging system of the present invention may be preferably implemented. As shown at FIG. 3, components of the QAnywhere messaging system include both client-side components on one or more client devices (e.g., mobile devices) connected via a network 330 to server-side components (e.g., on enterprise server systems). Although a single client is depicted at FIG. 3, a typical implementation environment would include a plurality of clients which connect from time to time to the server-side components of the present invention. As shown, the QAnywhere client components include a QAnywhere Application 310, a QAnywhere Client Library 311, a Message Store 320, QAnywhere synchronization Hooks 321, a QAnywhere Schema 322, a Transmission Rules Engine 323, a QAnywhere Agent 325, a MobiLink Synchronization Client (dbmisync) 326, and a MobiLink Listener (dbisn) 327. The QAnywhere server components include a MobiLink Server 340, aJMS Connector 343, Other Connectors 341-342, a QAnywhere Notifier 344, a Transmission Rules Engine 345, a Consolidated Database 350, and QAnywhere Synchronization Scripts 351. The client-side and server-side components and their operations are described in more detail below.

Client-Side QAnywhere Components

On the client-side (e.g., on a mobile device), the QAnywhere Agent 325 initializes the Message Store 320 with tables defined by the QAnywhere schema 322, and stored procedures and events. The QAnywhere Agent 325 also launches the MobiLink Listener (dblsn) 327 and the MobiLink synchronization client (dbmisync) 326 and controls synchronizations performed by the MobiLink synchronization client (dbmisync) 326, according to well-defined policies. In addition, the QAnywhere Agent 325 receives and processes push notifications and network status notifications from the MobiLink Listener (dblsn) 327. The QAnywhere Agent 325 interprets message transmission rules, and translates them into logic for initiating synchronizations, according to well-defined semantics for transmission rules.

The QAnywhere schema 322 is a set of relational database tables used to represent messages and delivery information in a relational database. The client-side QAnywhere schema 322 represents the structure of the set of tables used storing messages and related information in the relational database that serves as the message store at a mobile device. The following SQL statements used in the currently preferred embodiment of the present invention to initialize the Message Store 320 with the QAnywhere schema illustrate the structure of the client-side schema.

The ml_qa_repository_client table described below is the main table for storing message data:

1: CREATE TABLE “ml_qa_user_group”.“ml_qa_repository_client”
2: (

| | | |
|---|---|---|
| 3: | “seqno” | bigint NULL DEFAULT autoincrement , |
| 4: | “msgid” | varchar(128) NOT NULL , |
| 5: | “syncstatus” | integer NOT NULL DEFAULT 1 , |
| 6: | “originator” | varchar(128) NULL , |
| 7: | “priority” | integer NOT NULL DEFAULT 4 , |
| 8: | “expires” | timestamp NULL , |
| 9: | “props” | long binary NULL , |
| 10: | “kind” | integer NOT NULL DEFAULT 2 , |
| 11: | “content” | long binary NULL , |
| 12: | “contentsize” | integer NOT NULL , |

| | |
|---|---|
| 13: | PRIMARY KEY (“msgid”), |
| 14: | |
| 15: ) | |

The following provides a brief description of each of the columns of the ml_qa_repository_client table for storing message data:

Seqno—an autoincrement column used for message ordering.

Msgid—the primary key, the message ID.

Syncstatus—a flag indicating whether the row has been synchronized with the MobiLink server.

Originator—the message store ID of the originator of the message.

Priority—the priority of the message, an integer in the range [0, 9].

Expires—a timestamp column giving the expiry time of the message.

Props—a BLOB column that contains a serialized representation of the message properties.

Kind—a flag indicating the type of the message content: text or binary.

Content—a BLOB column containing the content of the message. For binary messages, it is the byte stream. For text messages it is the UTF-8 encoding of the character data.

Contentsize—an integer representing the number of bytes of binary content, or the number of characters of text content, depending on the type of message.

Another related table that is part of the client-side QAnywhere schema is the ml_qa_delivery_client table, the structure of which is illustrated below:

1: CREATE TABLE “ml_qa_user_group”.“ml_qa_delivery_client”
2: (

| | | |
|---|---|---|
| 3: | “msgid” | varchar(128) NOT NULL , |
| 4: | “address” | varchar(255) NOT NULL , |
| 5: | “target” | varchar(255) NULL , |
| 6: | “status” | integer NOT NULL DEFAULT 1 , |
| 7: | “statustime” | timestamp NOT NULL DEFAULT current |

timestamp ,

| | | |
|---|---|---|
| 8: | “verbiage” | varchar(32767) NULL , |
| 9: | “receiverid” | varchar(128) NULL , |
| 10: | “syncstatus” | integer NOT NULL DEFAULT 1 , |

| | |
|---|---|
| 11: | PRIMARY KEY (“msgid”, “address”, “status”), |
| 12: | |
| 13: ) | |

The ml_qa_delivery_client table stores delivery information for each message. The “msgid” column is a foreign key, referencing the ml_qa_repository_client table. The other columns of this table are described as follows:

Address—the full address of the message, e.g.,. “QBob\q1” for a message addressed to queue “q1” at store id “Bob”.

Target—the message store ID of the destination, “Bob” in the example immediately above.

Status—an integer indicating the current status of the message; can indicate pending, receiving, expired, unreceivable, received.

Statustime—a timestamp representing the time that the current status was attained.

Verbiage—a string representing additional human-readable status information.

Receiverid—an ID of the QAManager currently receiving the message.

Syncstatus—a flag indicating whether the row has been synchronized with the MobiLink server.

The client-side schema also includes an ml_qa_repository_props_client table for storing message properties as described below:

| 1: CREATE TABLE “ml_qa_user_group”.- | |
|---|---|
| “ml_qa_repository_props_client” | |
| 2: ( | |
| 3: “seqno” | bigint NULL DEFAULT autoincrement , |
| 4: “msgid” | varchar(128) NOT NULL , |
| 5: “name” | varchar(128) NOT NULL , |
| 6: “value” | varchar(32767) NULL , |

7: PRIMARY KEY (“msgid”, “name”),
8:
9: )

The ml_qa_repository_props_client table stores message properties, deserialized from their associated message, for use by the transmission rules engine. QAnywhere messages have three general elements: header information; properties; and a body (or payload). The properties are structured as name/value pairs and are stored in the above table. The properties are also actually encoded in a column of the message repository table, but are put into this separate table for convenience in referring to these properties in the transmission rules engine as described below in more detail. The columns of this table currently include the following:

Seqno—an autoincrement column for giving the table a total order.

Msgid—the message ID of the message this property is associated with. The msgid column is a foreign key, referencing the ml_qa_repository_client table.

Name—the name of the property.

Value—the value of the property, formatted as a string.

Additional properties are stored in an ml_qa_global_props_client table, the structure of which is illustrated below:

| 1: CREATE TABLE “ml_qa_user_group”.- | |
|---|---|
| “ml_qa_global_props_client” | |
| 2: ( | |
| 3: “name” | varchar(128) NOT NULL , |
| 4: “modifiers” | integer NOT NULL DEFAULT 0 , |
| 5: “value” | varchar(32767) NULL , |

6: PRIMARY KEY (“name”),
7:
8: )

The ml_qa_globals_props_client table is used to store message store properties. Message store properties are properties that are related to a message store rather than to a particular message or a particular QAManager (which represents a client connection to the message store). Message store properties are associated with a message store, meaning that they are global to all applications sharing the client-side message store at a device. A given mobile device (or client) may have multiple QAManagers, each of which is associated with a particular messaging enabled application. Generally, each thread in each application has its own QAManager and an application may have multiple connections to a message store. The set of properties in the above table are common to all applications connected to a particular client-side message store. Columns of the above table include the name of the property (“name”), a “modifiers” flag indicating whether the property should be synchronized with the consolidated database, and the value of the property (“value”), formatted as a string.

As described below, transmission rules may be provided to govern the delivery of messages from the server to the client as well as from client and server. Global properties may come into play in the evaluation of these transmission rules. The global properties can be set on a particular mobile device and subsequently moved to the server. This enables the server to make decisions on what messages should be sent to particular client device based on settings made at the particular client device (e.g., what types of messages are of interest to client). For example, when a client determines what network it is on, it can store that information in the global properties table and provide the information up to the server during the synchronization process. On the basis of this information, the server may apply server-side transmission rules for selecting messages to be downloaded to the client.

The next client-side table is an ml_qa_repository_content_client table, the structure of which is as follows:

| 1: CREATE TABLE “ml_qa_user_group”.- | |
|---|---|
| “ml_qa_repository_content_client” | |
| 2: ( | |
| 3: “msgid” | varchar(128) NOT NULL , |
| 4: “seqno” | integer NOT NULL , |
| 5: “content” | long binary NOT NULL , |

6: PRIMARY KEY (“msgid”, “seqno”),
7:
8: )

The above-described table is related to the main message content table (i.e., to ml_qa_repository_client ). For messages that are deemed to be too large to fit into RAM on a mobile device (e.g., because of memory limitations at the device), the message content is placed into this table in “chunks”. This allows the user application to read the message out a piece at a time (e.g., using a streaming API). The msgid column of this table is a foreign key, referencing the ml_qa_repository_client table. Another column of this table is “seqno”, which is an integer used for ordering the content chunks. The “content” column is for storing the actual chunks of content from the content column of the ml_qa_repository_client table.

The final table in the current client-side schema is the ml_qaagent_sync_status table which is structured as follows:

1: CREATE TABLE “ml_qa_user_group”.-
“ml_qaagent_sync_status”
2: (

| | |
|---|---|
| 3: “ml_user” | varchar(128) NOT NULL , |
| 4: “sync_flag” | integer NOT NULL , |
| 5: “last_modified” | timestamp NOT NULL DEFAULT timestamp , |

6: PRIMARY KEY (“ml_user”),
7:
8: )

The ml_qaagent_sync_status table is an internal use only table that does not have information directly relating to messages. It is used for storing information used by the QAnywhere Agent for managing the synchronization process. The “ml_user” column is used for storing the ID of the message store. The message store ID is used by the system for directing messages to a message store on a particular device. Other fields of this table include a “sync_flag” column and a “last_modified” column. The sync_flag has a number of settings that control how synchronization is performed which are described below. The last_modified column is used for debugging purposes. The sync_flag values used in the currently preferred embodiment of the present invention are as follows:

1: sync_flag values
2: ----------------
3: 0x00000000 - do not sync
4: 0x00000001 - triggerSendReceive( ) was called from a QAnywhere
client application
5: 0x00000002 - message repository insert or update triggers were fired
6: 0x00000004 - a push notification was received from the server
7: 0x00000008 - a status change notification was received from the server
8: 0x00000010 - a network status change notification was received from
dblsn
9: 0x00YY0020 - delayed sync
10: 0x00000040 - scheduled sync
11: 0x00000080 - trigger send sync
12: 0x00000800 - sync unconditionally

The above schema is used to create the QAnywhere Message Store database 320. The QAnywhere Message Store 320 is a database that acts as a persistent store for messages. In the currently preferred embodiment of the present invention, the client Message Store 320 is serviced by an Adaptive Server® Anywhere (ASA) relational database server (available from iAnywhere Solutions, Inc. of Dublin, Calif.). Those skilled in the art will appreciate that an alternative database or storage system may also be used, if desired. Currently, the Message Store database 320 for storing messages is implemented separately from the databases used for data storage (i.e., storage of application data or other non-message data). However, a mixture of messages and application data could also be stored in a single database, if desired.

The MobiLink Synchronization Client 326 performs several functions in support of the operations of the present invention. It performs synchronization of the data in the (client) QAnywhere Message Store 320 with a similar schema in the QAnywhere server message store (i.e., consolidated database 350). The MobiLink Synchronization Client 326 executes QAnywhere synchronization hooks (as depicted at 321 at FIG. 3) defined by the QAnywhere Agent 325 to customize the synchronization process for QAnywhere. In the currently preferred embodiment of the present invention, the following SQL statement creates the publication that is used by the MobiLink synchronization client:

1: CREATE PUBLICATION “ml_qa_user_group”.-
“ml_qa_repository_pub”
2: (
3: TABLE “ml_qa_user_group”.“ml_qa_repository_client”(
“seqno”, “msgid”, “originator”, “priority”, “expires”, “props”, “kind”,
“content”, “contentsize” ) WHERE syncstatus in(1,3) ,
4:
5: TABLE “ml_qa_user_group”.“ml_qa_delivery_client”( “msgid”,
“address”, “target”, “status”, “statustime”, “verbiage” ) WHERE
syncstatus in(1,3) ,
6:
7: TABLE “ml_qa_user_group”.“ml_qa_global_props_client”(
“name”, “modifiers”, “value”) WHERE (modifiers&1) = 0
8: )

The above publication includes three tables which are to be synchronized between the client and the server: ml_qa_repository client, ml_qa_delivery_client, and ml_qa_global_props_client (each of which are described above). Also note that there is WHERE clause on each of the tables indicating the subset of rows of such tables that are to be involved in the synchronization. A “publication” describes a set of tables that are to be synchronized by the MobiLink synchronization server between the message store database at a mobile client and a consolidated database at the server. The publication may be further limited to contain only a subset of the rows and/or columns in the table(s) as shown above.

The MobiLink Listener 327 receives push notifications from the QAnywhere Notifier 344, and relays them to the QAnywhere Agent 325. A push notification is sent by the QAnywhere Notifier 344 (on the server) to a MobiLink Listener 327 (on a mobile client) when it detects that a message is destined for a message store on that mobile client. The Listener 327 also detects changes in the network status on the mobile client and sends network status notifications to the (local) QAnywhere Agent as well as updating the server with changes in the network address (IP address) of the mobile client.

The Transmission Rules Engine 323 is a “compiler” of transmission rules, invoked by the QAnywhere Agent 325 on the client. The Transmission Rules Engine 323 compiles SQL-like rules into stored procedures and events that are invoked by the message store database server (i.e., Message Store 320 on the client) during data synchronization. These stored procedures control which messages get uploaded to the MobiLink server 340 according to the semantics of transmission rules. The syntax and semantics of transmission rules are described below in this document in more detail.

The QAnywhere Client Library 311 provides an API for putting messages into queues in the Message Store 320, and for getting messages from queues in the Message Store 320. It encodes/decodes message objects to/from the QAnywhere message schema. The QAnywhere Client Library 311provides transactional and non-transactional modes of operation. The API of the Client Library 311 allows an application to control when message transmissions are to occur. Currently, the policies that are defined and available for use are referred to as “scheduled”, “automatic”, and “ondemand”. With a “scheduled” policy, message transfers are done at regular, specified time intervals. With an “automatic” policy, the QAnywhere messaging system attempts to perform message transmissions exactly when needed. With an “ondemand” policy, the messaging system leaves it to the messaging application to control when message transfers are performed. For application-controlled message transmissions, the QAnywhere Agent 325 is started with an “ondemand” policy.

Server-Side QAnywhere Components

The QAnywhere server components include a Consolidated Database 350 which acts as a persistent store for messages. In the currently preferred embodiment, the Consolidated Database 350 is a relational database. The Consolidated Database 350 can be implemented using Adaptive Server Anywhere, Sybase® Adaptive Server® Enterprise, Oracle, Microsoft SQL Server, IBM DB2, or other ODBC-compliant database systems. As shown below, the schema for the consolidated database on the server includes basically the same tables as the schema as that of the message store databases on the mobile clients. The following illustrates the current QAnywhere schema for the Consolidated Database:

| | |
|---|---|
| 1: | create table dbo.ml_qa_repository ( |
| 2: | seqno bigint default autoincrement, |
| 3: | msgid varchar(255) not null primary key, |
| 4: | originator varchar(255) null, |
| 5: | priority integer default 4 not null, |
| 6: | expires timestamp null, |
| 7: | props long binary null, |
| 8: | kind integer default 2 not null, |
| 9: | content long binary null, |
| 10: | contentsize bigint not null ) in SYSTEM |
| 11: | |
| 12: | create table dbo.ml_qa_delivery ( |
| 13: | msgid varchar(255) not null references dbo.ml_qa_repository |
| 14: | on delete cascade, |
| 15: | address varchar(255) not null, |
| 16: | client varchar(255) not null, |
| 17: | status integer not null default 1, |
| 18: | statustime timestamp default current timestamp not null, |
| 19: | verbiage varchar(32767) null, |
| 20: | syncstatus integer default 3 not null, |
| 21: | receiverid varchar(128) null, |
| 22: | last_modified timestamp not null default current timestamp, |
| 23: | primary key( msgid, address, status ) ) in SYSTEM |
| 24: | |
| 25: | create table dbo.ml_qa_repository_props ( |
| 26: | msgid varchar(255) not null references dbo.ml_qa_repository |
| 27: | on delete cascade, |
| 28: | name varchar(255) not null, |
| 29: | value varchar(32767), |
| 30: | primary key( msgid, name ) ) in SYSTEM |
| 31: | |
| 32: | create table dbo.ml_qa_global_props ( |
| 33: | client varchar(255) not null default ”, |
| 34: | name varchar(255) not null, |
| 35: | modifiers integer not null, |
| 36: | value varchar(32767), |
| 37: | last_modified timestamp not null default timestamp, |
| 38: | primary key( client, name ) ) in SYSTEM |

The QAnywhere Synchronization Scripts 351 control how data is synchronized between the QAnywhere schema in the Consolidated Database 350 and the QAnywhere schema in the client message stores (e.g., Message Store 320 at a client device). Some examples of these scripts and how they are invoked during synchronization are described below in this document.

The MobiLink Server 340 coordinates data synchronization between the Consolidated Database 350 and many client message stores. In the currently preferred embodiment of the present invention, the MobiLink server is implemented using the MobiLink synchronization server (dbmisrv9) of the SQL Anywhere® Studio product (available from iAnywhere Solutions, Inc. of Dublin, Calif.). The MobiLink Server 340 is started with an—m option which enables QAnywhere messaging. MobiLink allows a user to choose selected portions of the data for synchronization. MobiLink synchronization also provides for resolving conflicts between changes made in different databases. The synchronization process is controlled by synchronization logic, which can, for example, be written as a SQL, Java, or .NET application. Each piece of logic is called a script. With scripts, for example, a user can specify how uploaded data is applied to the Consolidated Database, specify what gets downloaded, and handle different schema and names between the consolidated and remote databases.

A MobiLink synchronization can be initiated from the server or from the mobile client. Initiating a synchronization from the server enables data updates to be pushed to remote databases and can also be used to cause remote databases to upload data to the Consolidated Database. Currently, synchronization can be carried out over TCP/IP, HTTP, or HTTPS. Palm devices can synchronize through HotSync and Windows CE devices can synchronize using ActiveSync. MobiLink is session-based, meaning that all changes are uploaded in a single transaction and downloaded in a single transaction. At the end of each successful synchronization, the consolidated and remote databases are consistent. Generally either a whole transaction is synchronized, or none of it is synchronized, so as to ensure transactional integrity for each database. MobiLink operates using a loose consistency policy. All changes are synchronized with each site over time in a consistent manner, but different sites may have different copies of data at any instant. A single MobiLink server can handle thousands of simultaneous synchronizations, and multiple MobiLink servers can be run simultaneously using load balancing. The MobiLink synchronization server is multi-threaded and uses connection pooling with the Consolidated Database.

The QAnywhere Notifier 344 runs in the MobiLink Server 340. Its purpose is to detect when messages in the Consolidated Database 350 are ready to be sent to QAnywhere clients, and to initiate push notifications to the appropriate mobile clients. These push notifications cause the applicable QAnywhere Agents (e.g., QAnywhere Agent 325 as shown at FIG. 3) to initiate a data synchronization with the MobiLink Server 340, which results in the messages in the Consolidated Database 350 being delivered to the client message stores (e.g., Message Store 320 as shown at FIG. 3). A push notification is a special message delivered from the server to a QAnywhere client. The QAnywhere Notifier is a specially configured instance of a MobiLink Notifier that sends push notifications when a message is ready for delivery. At the client, a QAnywhere Listener receives these push notifications and passes them on to the QAnywhere Agent. If push notifications are not used, messages are still transmitted from the server message store to the client message store, but the transmission must be initiated at the client, such as by using a scheduled transmission.

The JMS Connector 343 also runs in the MobiLink Server 340. Its purpose is to form a connection between an enterprise messaging system that supports Java Message Service (JMS), and QAnywhere mobile client applications. In addition to exchanging messages among QAnywhere applications, the present invention can be used for exchanging messages with messaging systems that have aJMS interface using the JMS Connector 343. JMS is the Java Message Service API for adding messaging capabilities to Java applications. The JMS Connector 343 provides an interface between QAnywhere and the enterprise messaging system. The JMS Connector is a special QAnywhere client that moves messages between QAnywhere and the external JMS system. In a similar fashion, interfaces to other messaging systems can also be implemented as illustrated at FIG. 3 by connectors 341-342.

The Transmission Rules Engine 345 is a server-side “compiler” of transmission rules, invoked by the MobiLink Server 340. It serves a role similar to the client-side Transmission Rule Engine 323 by compiling SQL-like rules into stored procedures and events that are invoked by the Consolidated Database server 350 during data synchronization. These stored procedures control which messages get downloaded to the QAnywhere clients according to the semantics of transmission rules. The creation and application of transmission rules is described below in more detail.

Detailed Operation

The following description presents method steps that may be implemented using processor-executable instructions, for directing operation of a device under processor control. The processor-executable instructions may be stored on a computer-readable medium, such as CD, DVD, flash memory, or the like. The processor-executable instructions may also be stored as a set of downloadable processor-executable instructions, for example, for downloading and installation from an Internet location (e.g., Web server).

The following illustrates the operations of the present invention using an example of a message that is being sent from a mobile client with message store ID “A” to a mobile client with message store ID “B”. It is further assumed that the message is being sent to queue “q” in message store “B”. To accomplish this, the QAnywhere application running on the mobile client with message store “A” addresses the message to the queue “B\q”. Also, for purposes of this example it is assumed that the QAnywhere Agents on both the sending client and the receiving client are running with an “automatic” policy. As described above, this message flow involves two phases. In the first phase, the sending client (with message store ID “A”) sends the message to the server message store (consolidated database). In the second phase, the message is sent from the consolidated database at the server to the recipient (the mobile client with the message store “B”). Both of these phases are described below.

Sending Message from Application on Mobile Client to Central Server

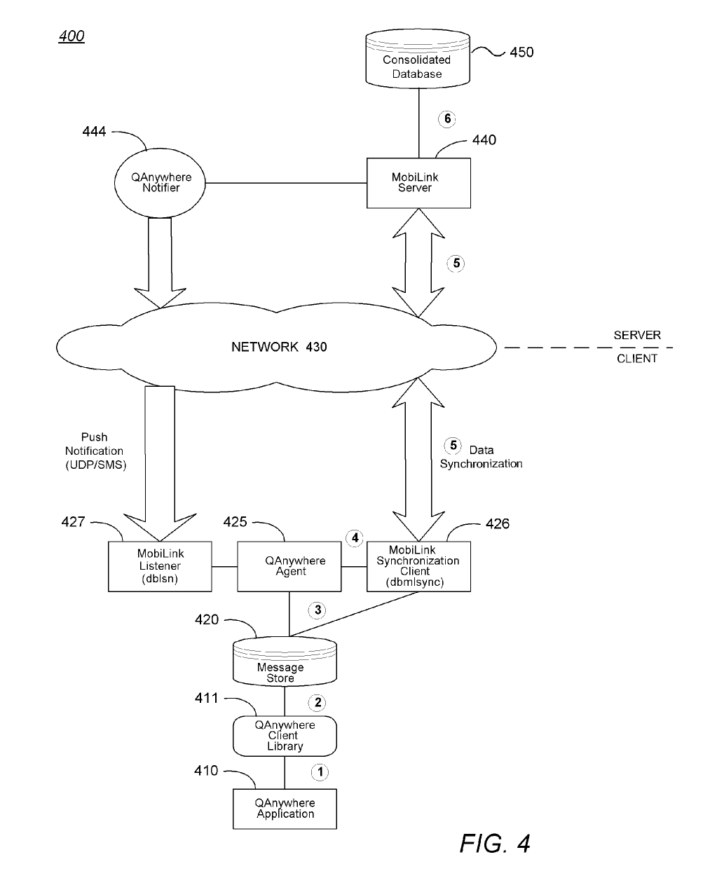

FIG. 4 is a flow diagram 400 illustrating the sequence of interactions as the message flows from the sending QAnywhere application to the server message store (consolidated database). At step 1at FIG. 4, the application (QAnywhere application 410) creates a message object using APIs from the QAnywhere client library 411, and then uses an API from the client library 411 to put the message on a queue (i.e., a queue at the client device with message store “A”, which is shown as Message Store 420 at FIG. 4). At step 2 at FIG. 4, the QAnywhere client library 411inserts the message into message tables in the Message Store 420, according to the QAnywhere schema (not separately shown at FIG. 4). This process triggers an event in the database server that wakes up the QAnywhere Agent 425. In the currently preferred embodiment of the present invention, the following are the SQL statements used to insert the message into the message store:

1: INSERT INTO ml_qa_user_group.ml_qa_repository_{—}
client(msgid, originator, expires, priority, props, kind, content,
contentsize) ON EXISTING UPDATE VALUES(?, ?, ?, ?, ?, ?, ?, ?)
2:
3: INSERT INTO ml_qa_user_group.ml_qa_delivery_{—}
client(msgid, address, target, status, verbiage, receiverid) ON EXISTING
UPDATE VALUES(?, ?, ?, ?, ?, ?)
4:
5: INSERT INTO ml_qa_user_group.ml_qa_repository_{—}
props_client(msgid, name, value) ON EXISTING UPDATE
VALUES(?,?,?)

1: sprintf(stmt,
“call ” QA_TAB_OWNER “.ml_qa_update_sync_status(%d)”,
SYNC_STAT_REPOS_CHG);
2: EXEC SQL EXECUTE IMMEDIATE :stmt;

1: create procedure ml_qa_user_group.ml_qa_update_sync_status(in mask
integer)
2: begin

| | |
|---|---|
| 3: | declare connid varchar(128); |
| 4: | update ml_qa_user_group.ml_qaagent_sync_status set sync_flag = |

sync_flag | mask;

| | |
|---|---|
| 5: | -- Waitfor/message |
| 6: | set |

connid=ml_qa_user_group.ml_qa_get_global_property(‘dbmlsync_conn_id’);

| | |
|---|---|
| 7: | call dbo.ml_qa.sql_message(connid.‘sync’) |
| 8: end | |

Next, at step 3 shown at FIG. 4, the QAnywhere Agent 425 determines that there is a message ready to transmit to the server. The following is the stored procedure that is called in a thread in the QAnywhere Agent that determines if a synchronization needs to take place:

```
1: create procedure ml_qa_user_group.ml_qa_wait_hook(in uu
varchar(128),in sflag integer,in delay_in_seconds varchar(128),in
policy varchar(256),out rr bit)
2: begin
3: declare should_wait bit;
4: declare delay_duration integer;
5: if policy = ‘automatic’ or policy = ‘ondemand’ then
6: if policy = ‘automatic’ and
7: (sflag&0x04 <> 0 or
8: sflag&0x01 <> 0 or
9: sflag&0x40 <> 0 or
10: sflag&0x08 <> 0) then
11: -- these conditions cause a sync for automatic policy,
12: -- but only TriggerSendReceive causes a sync for ondemand
          policy
13: set should_wait=0
14: elseif sflag&0x80 <> 0 and
15: ml_qa_user_group.ml_qa_has_messages_to_upload(uu) > 0
      then
16: set should_wait=0
17: elseif sflag&0x01 <> 0 then
18: set should_wait=0
19: elseif policy = ‘automatic’ and
20: (sflag&0x10 <> 0 or
21: sflag&0x02 <> 0) and
22: ml_qa_user_group.ml_qa_has_messages_to_upload(uu) > 0
      then
23: set should_wait=0
24: elseif policy = ‘automatic’ and(sflag&0x20 <> 0) then
25: set delay_duration=sflag&0x00FF0000;
26: set delay_duration=delay_duration/power(2,16);
27: set delay_duration=delay_duration*5;
28: if delay_duration >= 60*60 then
29: set delay_in_seconds=‘1:0:0’
30: elseif delay_duration > 59 then
31: set delay_in_seconds=‘0:’ || cast((delay_duration/60) as
varchar(256)) || ‘:’ ||
32: cast(mod(delay_duration,60) as varchar(256))
33: else
34: set delay_in_seconds=‘0:0:’ || cast(delay_duration as
varchar(256))
35: end if;
36: -- Waitfor/message
37: waitfor delay delay_in_seconds check every 100;
38: set should_wait=0
39: else
40: set should_wait=1
41: end if
42: elseif policy = ‘scheduled’ then
43: if sflag&0x04 <> 0 or
44: sflag&0x01 <> 0 or
45: sflag&0x40 <> 0 or
46: sflag&0x08 <> 0 then
47: set should_wait=0
48: elseif sflag&0x80 <> 0 and
49: ml_qa_user_group.ml_qa_has_messages_to_upload(uu) > 0
      then
50: set should_wait=0
51: else
52: set should_wait=1
53: end if
54: else
55: set should_wait=1
56: end if;
57: if should_wait = 1 then
58: -- Waitfor/message
59: waitfor delay delay_in_seconds check every 100
60: end if;
61: set rr=should_wait
62: end
```

Note that the “waitfor” statement in the above procedure blocks until signaled by the stored procedure illustrated above in step 2. At step 4 at FIG. 4, the QAnywhere Agent 425 signals the MobiLink synchronization client 426 to perform a synchronization. The following is the thread procedure in the QAnywhere Agent that signals the MobiLink synchronization client.

1: void synchronizationEventThread( )
2: /*******************************/
3: {
4: exec sql set sqlca “sqlca_ptr”;
5: SQLCA *sqlca_ptr = NULL;
6: HWND hw = NULL;
7: UINT msgid;
8: bool shouldWait;
9:
10: sqlca_ptr = (SQLCA *)malloc( sizeof( SQLCA ) );
11: if( sqlca_ptr == NULL ) {
12: return;
13: }
14: db_init( sqlca_ptr );
15:
16: if( !connectDB( sqlca_ptr ) ) {
17: internalSQLError( sqlca_ptr );
18: return;
19: }
20: synchronizationEventThreadMutex = CreateMutex( NULL, FALSE, NULL);
21: synchronizationEventThreadSQLCA = sqlca_ptr;
22: exec sql whenever sqlerror {
23: internalSQLError( sqlca_ptr );
24: };
25: for(;;) {
26: MessageDeleteManager deleteMgr( sqlca_ptr, ml_userid );
27: SyncWaitManager syncWaitMgr( sqlca_ptr, ml_userid );
28:
29: if( !syncWaitMgr.init( ) || !deleteMgr.init( ) ) {
30: break;
31: }
32: db_register_a_callback( sqlca_ptr, DB_CALLBACK_MESSAGE,
33: (SQL_CALLBACK_PARM)&cancelSyncEventWait );
34: msgid = RegisterWindowMessage( _T( “dbas_synchronize” ) );
35:
36: syncEventThreadState = RUNNING;
37:
38: exec sql whenever sqlerror continue;
39:
40: for(;;) {
41: WaitForSingleObject( synchronizationEventThreadMutex, INFINITE);
42: sync_event_wait = TRUE;
43: ReleaseMutex( synchronizationEventThreadMutex );
44:
45: if( syncEventThreadState != RUNNING ) {
46: WaitForSingleObject( synchronizationEventThreadMutex, INFINITE );
47: sync_event_wait = FALSE;
48: ReleaseMutex( synchronizationEventThreadMutex );
49: break;
50: }
51: shouldWait = syncWaitMgr.wait( );
52:
53: WaitForSingleObject( synchronizationEventThreadMutex, INFINITE);
54: sync_event_wait = FALSE;
55: ReleaseMutex( synchronizationEventThreadMutex );
56:
57: if( syncEventThreadState != RUNNING ) {
58: WaitForSingleObject( synchronizationEventThreadMutex, INFINITE );
59: sync_event_wait = FALSE;
60: ReleaseMutex( synchronizationEventThreadMutex );
61: break;
62: }
63:
64: if( SQLCODE == SQLE_LOCKED ) {
65: // We were blocked, so sleep a little and try again
66: internalSQLError( sqlca_ptr );
67: Sleep( 1000 );
68: } else if( SQLCODE == SQLE_NOERROR && !shouldWait ) {
69: syncWaitMgr.updateSyncFlag( );
70:
71: if( SQLCODE != SQLE_NOERROR ) {
72: internalSQLError( sqlca_ptr );
73: }
74: deleteMgr.deleteMessages( );
75: if( hw == NULL ) {
76: hw = FindWindow( dbmlsync_wc, NULL );
77: }
78: if( hw != NULL ) {
79: logVerbose( IDS_QAAGENT_INIT_SYNC, LOG_SYNC_INITS );
80: PostMessage( hw, msgid, 0, 0 );
81: } else {
82: logError( IDS_QAAGENT_INIT_SYNC_FAILED_NO_DBMLSYNC );
83: }
84: } else if( SQLCODE != SQLE_NOERROR && SQLCODE !=
SQLE_INTERRUPTED ) {
85: // Some other error, so report error, sleep and try again
86: internalSQLError( sqlca_ptr );
87: Sleep( 1000 );
88: } else if( SQLCODE == SQLE_NOERROR ) { // && shouldWait
89: deleteMgr.deleteMessages( );
90: } else { // SQLCODE == SQLE_INTERRUPTED
91: }
92: }
93: break;
94: }
95: exec sql disconnect;
96: db_fini( sqlca_ptr );
97: WaitForSingleObject( synchronizationEventThreadMutex, INFINITE );
98: syncEventThreadState = STOPPED;
99: ReleaseMutex( synchronizationEventThreadMutex );
100: }

As shown above, the mechanism currently used for signaling purposes is a Windows message. The call to “PostMessage” sends the Windows message. At step 5 at FIG. 4, the MobiLink synchronization client 426 performs a data synchronization of the QAnywhere message schema with the MobiLink server 440. The message that is to be sent is included in the upload portion of the synchronization. Finally, at step 6 the message is inserted into the server message store (i.e., consolidated database 450 at the server). If, for some reason, the transaction with the message insert is rolled back, the synchronization process fails and the MobiLink synchronization client 426 is notified of the error and the status of the message remains as “waiting for transmission”.

Sending Message from Server to Mobile Client

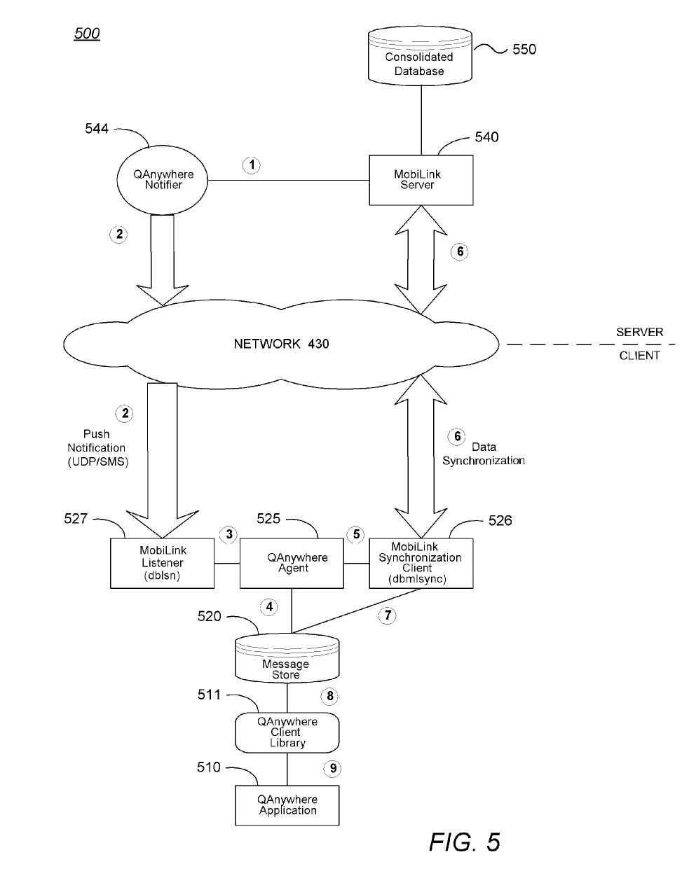

FIG. 5 is a flow diagram 500 illustrating the sequence of interactions as the message flows from the consolidated database 550 on the server (i.e., server message store) to a receiving QAnywhere application. At stepl at FIG. 5, the QAnywhere Notifier 544 running in the MobiLink server 540 determines that there is a message in the server message store (consolidated database 550) destined for a remote client. In this case, the message is destined for the remote client having message store ID “B”, and for purposes of the following discussion assume that the device (remote client) with store ID “B” is currently available to receive a push notification.

At step 2 at FIG. 5, the QAnywhere Notifier 544 sends a push notification to the network address of the mobile client with message store “B”. At step 3, the MobiLink Listener 527 running on the mobile client with message store “B” (i.e., Message Store 520 as shown at FIG. 5) receives the push notification and signals the QAnywhere Agent 525. The following is the procedure that runs in a thread in the QAnywhere Agent and receives push notifications from the MobiLink Listener. Both push notifications and network status notifications are received on a listening TCP/IP socket.

```
1: void listenerThreadMain( )
2: /***********************/
3: {
4: WSADATA WSAData;
5: SOCKET s;
6: int status;
7: SOCKADDR_IN local_sin; /* Local socket - internet style */
8: SOCKADDR_IN acc_sin; /* Accept socket address - internet
style */
9: int acc_sin_len; /* Accept socket address length */
10: SOCKET cs;
11: fd_set fds;
12: fd_set cfds;
13: struct timeval to;
14: char *buffer = NULL;
15: int lenRcvd;
16:
17: acc_sin_len = sizeof( acc_sin );
18: memset( &local_sin, 0, sizeof(SOCKADDR_IN) );
19: memset( &acc_sin, 0, acc_sin_len );
20: status = WSAStartup( MAKEWORD(1,1), &WSAData );
21: if( status != 0 ) {
22: //_tprintf( _T(“listener thread error %d\n”),
WSAGetLastError( ) );
23: logError( IDS_QAAGENT_LT_ERROR,
WSAGetLastError( ) );
24: return;
25: }
26: s = socket( AF_INET, SOCK_STREAM, 0 );
27: if( s == INVALID_SOCKET ) {
28: //_tprintf( _T(“listener thread error %d\n”),
WSAGetLastError( ) );
29: logError( IDS_QAAGENT_LT_ERROR,
WSAGetLastError( ) );
30: goto done;
31: }
32: memset( &local_sin, 0, sizeof( local_sin ) );
33: local_sin.sin_family = AF_INET;
34: local_sin.sin_addr.s_addr = INADDR_ANY;
35: local_sin.sin_port = htons( (u_short)listenerPort );
36: if( bind( s, (struct sockaddr FAR *) &local_sin,
sizeof(local_sin))==SOCKET_ERROR ) {
37: closesocket(s);
38: logError( IDS_QAAGENT_LT_ERROR,
          WSAGetLastError( ) );
39: //_tprintf( _T(“listener thread error %d\n”),
WSAGetLastError( ) );
40: goto done;
41: }
42: if( listen( s, 2 ) < 0 ) {
43: closesocket(s);
44: logError( IDS_QAAGENT_LT_ERROR,
          WSAGetLastError( ) );
45: //_tprintf( _T(“listener thread error %d\n”),
WSAGetLastError( ) );
46: goto done;
47: }
48:
49: buffer = (char *)malloc( 16384 * sizeof( char ) );
50: if( buffer == NULL ) {
51: goto done;
52: }
53: logInfo( IDS_QAAGENT_LT_STARTED, listenerPort );
54: //_tprintf( _T(“listener thread started, listening on port
%d\n”), listenerPort );
55: listenerThreadState = RUNNING;
56: FD_ZERO( &fds );
57: FD_ZERO( &cfds );
58: to.tv_sec = 1L; // 1 second allows thread to terminate on
        shutdown
59: to.tv_usec = 0L;
60: while( listenerThreadState == RUNNING ) {
61: FD_SET( s, &fds );
62: status = select( 0, &fds, NULL, NULL, &to );
63: if( status > 0 ) {
64: cs = accept( s, (struct sockaddr FAR *) &acc_sin, (int
FAR *) &acc_sin_len );
65: if( cs >= 0 ) {
66: memset( &cfds, 0, sizeof( cfds ) );
67: FD_SET( cs, &cfds );
68: status = select( 0, &cfds, NULL, NULL, &to );
69: if( status > 0 ) {
70: status = recv( cs, buffer, 16384, 0 );
71: if( status > 0 ) {
72: lenRcvd = status;
73: buffer[lenRcvd] = ‘\0’;
74: if( processListenerAgentMessage( buffer ) ) {
75: send( cs, “ack”, 3, 0 );
76: }
77: }
78: }
79: closesocket( cs );
80: } else {
81: logError( IDS_QAAGENT_LT_ERROR,
              WSAGetLastError( ) );
82: //_tprintf( _T(“listener thread error %d\n”),
WSAGetLastError( ) );
83: }
84: } else if( status == 0 ) {
85: // timeout on select
86: } else {
87: // error on select
88: logError( IDS_QAAGENT_LT_ERROR,
            WSAGetLastError( ) );
89: //_tprintf( _T(“listener thread error %d\n”),
WSAGetLastError( ) );
90: break;
91: }
92: }
93: closesocket(s);
94: //_tprintf( _T(“listener thread finished\n”) );
95: logInfo( IDS_QAAGENT_LT_FINISHED );
96: listenerThreadState = STOPPED;
97: free( buffer );
98:
99: done:
100: WSACleanup( );
101: }
```

At step 4 at FIG. 5, the QAnywhere Agent 525 sends a message to the “system” queue in the Message Store 520 indicating that a push notification was received. The following is the procedure in the QAnywhere Agent 525 that sends push notification as a QAnywhere message into the “system” queue:

1: void sendSystemMessage( SQLCA *sqlca_ptr, int mtype, const char
*message )
2: /*******************************************************************/
3: {
4: exec sql set sqlca “sqlca_ptr”;
5: EXEC SQL BEGIN DECLARE SECTION;
6: char *cmd;
7: char dest[256];
8: DECL_BINARY( 4000 ) props;
9: int kind;
10: DECL_BINARY( 1 ) content;
11: DECL_BIGINT contentsize;
12: short int ind_content;
13: EXEC SQL END DECLARE SECTION;
14: int propsLen;
15: BOOL connected = FALSE;
16: char *buffer = NULL;
17: char *dstptr;
18: const char *srcptr;
19:
20: cmd = NULL;
21: cmd = (char *)malloc( 4096*sizeof(char) );
22: if( cmd == NULL ) {
23: goto done;
24: }
25: if( message != NULL ) {
26: buffer = (char *)malloc( ( strlen( message ) + 1
)*sizeof(char) );
27: if( buffer == NULL ) {
28: goto done;
29: }
30: }
31: strcpy( dest, “Q” );
32: strcat( dest, ml_userid );
33: strcat( dest, “\\system” );
34:
35: propsLen = 0;
36: propsLen += writeUTF( props.array, propsLen,
QA_MESSAGE_PROPERTY_MESSAGE_TYPE,
37: 4000 − propsLen );
38: props.array[ propsLen++ ] = ‘I’;
39: writeInt( props.array, propsLen, mtype );
40: propsLen += 4;
41:
42: if( mtype == 14 ) { // NETWORK_STATUS_NOTIFICATION
43: srcptr = message;
44: dstptr = buffer;
45: while( *srcptr != ADAPTER_NETWORK_NAME_DELIMITER_CHAR[0] ) {
46: *dstptr++ = *srcptr++;
47: }
48: *dstptr = ‘\0’;
49: if( strlen( buffer ) > 0 ) {
50: connected = TRUE;
51: propsLen += writeUTF( props.array, propsLen,
QA_MESSAGE_PROPERTY_ADAPTER,
52: 4000 − propsLen );
53: props.array[ propsLen++ ] = ‘T’;
54: propsLen += writeUTF( props.array, propsLen, buffer, 4000
− propsLen );
55: }
56:
57: srcptr++;
58: dstptr = buffer;
59: while( *srcptr != ADAPTER_NETWORK_NAME_DELIMITER_CHAR[0] ) {
60: *dstptr++ = *srcptr++;
61: }
62: *dstptr = ‘\0’;
63: if( strlen( buffer ) > 0 ) {
64: connected = TRUE;
65: propsLen += writeUTF( props.array, propsLen,
QA_MESSAGE_PROPERTY_NETWORK,
66: 4000 − propsLen );
67: props.array[ propsLen++ ] = ‘T’;
68: propsLen += writeUTF( props.array, propsLen, buffer, 4000
− propsLen );
69: }
70: propsLen += writeUTF( props.array, propsLen,
QA_MESSAGE_PROPERTY_NETWORK_STATUS,
71: 4000 − propsLen );
72: props.array[ propsLen++ ] = ‘I’;
73: if( connected ) {
74: writeInt( props.array, propsLen, 1 );
75: } else {
76: writeInt( props.array, propsLen, 0 );
77: }
78: propsLen += 4;
79: }
80:
81: props.len = propsLen;
82: kind = 2;
83: contentsize = −1L;
84: ind_content = −1;
85: sprintf( cmd, “call “ QA_TAB_OWNER ”.ml_qa_addmessage( :?, :?,
:?, :?, :? )” );
86: EXEC SQL PREPARE S5 FROM :cmd;
87: if( SQLCODE == SQLE_NOERROR ) {
88: EXEC SQL EXECUTE S5 USING :dest, :props, :kind,
89: :content:ind_content, :contentsize;
90: if( SQLCODE == SQLE_NOERROR ) {
91: EXEC SQL COMMIT WORK;
92: } else {
93: sqlStmtError( sqlca_ptr, cmd );
94: EXEC SQL ROLLBACK WORK;
95: }
96: EXEC SQL DROP STATEMENT S5;
97: } else {
98: sqlStmtError( sqlca_ptr, cmd );
99: EXEC SQL ROLLBACK WORK;
100: }
101:
102: done:
103: if( cmd != NULL ) {
104: free( cmd );
105: }
106: if( buffer != NULL ) {
107: free( buffer );
108: }
109: }

The following stored procedure adds the message to the message store:

1: create procedure ml_qa_user_group.ml_qa_addmessage(in pdest
varchar(255),
2:: in pprops varbinary(32767),
3:: in pkind integer,
4:: in pcontent varbinary(32767),
5:: in pcontentsize bigint)
6:: begin
7:: declare exp timestamp;
8:: declare newmsgid varchar(128);
9:: set exp=datetime(dateadd(minute,1 ,getdate(*)));
10: set newmsgid=‘ID:’ || uuidtostr(newid(*));
11: insert into ml_qa_user_group.ml_qa_repository_client(
12: msgid,syncstatus,expires,props,kind,content,contentsize)
13: values( newmsgid,2,exp,pprops,pkind,pcontent,pcontentsize) ;
14: insert into ml_qa_user_group.ml_qa_delivery_client(
msgid,address,syncstatus)
15: values( newmsgid,pdest,2)
16: end

At step 5 at FIG. 5, the QAnywhere Agent 525 signals the MobiLink synchronization client 527 to perform a synchronization with the server. The signaling mechanism used is the same as that described above in the case of a message that is sent from the mobile client to the server. Next, at step 6, the MobiLink synchronization client 527 performs a data synchronization of the QAnywhere message schema with the MobiLink server 540. The message that is to be received by the client is included in the download portion of the synchronization (i.e., the portion transmitted from the server to the client).

The message is inserted into the client Message Store 520 at step 7 at FIG. 5. If, for some reason, the transaction with the message insert is rolled back, the synchronization process fails and the MobiLink synchronization client 527 is notified of the error and the status of the message on the server is still “waiting for transmission”. At step 8, if there is a call to the QAnywhere client library 511 waiting to get a message from queue “q”, or there is a message listener active for queue “q”, an event in the database server triggers the QAnywhere client library 511 to get the message from the Message Store 520. Otherwise, the message is kept in the queue in the Message Store 520. The following is the trigger in the database server that causes the QAnywhere client library 511 to get the message from the Message Store 520:

1: create trigger
ml_qa_user_group.ml_qa_user_group.
ml_qa_repository_client_after_ins_trig after insert on
ml_qa_user_group.ml_qa_repository_client
2: referencing new as newrow
3: for each row begin call
ml_qa_user_group.ml_qa_signal_waiters( )
4: end
5:
6: create procedure ml_qa_user_group.ml_qa_signal_waiters( )
7: begin
8: declare connid varchar(128);
9: declare conn_id_cursor dynamic scroll cursor for select distinct
value from
10: ml_qa_user_group.ml_qa_global_props_client where
11: name like ‘wait:%’;
12: open conn_id_cursor;
13: conn_id_loop: loop
14: fetch next conn_id_cursor into connid;
15: if sqlstate = ‘02000’ then
16: leave conn_id_loop
17: end if;
18: call dbo.ml_qa_sql_message(connid,‘recv’)
19: end loop conn_id_loop;
20: close conn_id_cursor;
21: call dbo.ml_qa_trigger_listener_event( )
22: end

The following is stored procedure that is called by the QAnywhere client library to wait for the signal to receive a message. It is called on a background thread in the case that there are message listeners active. It is called directly by the “getMessage” method in the case of a blocking receive.

1: create procedure ml_qa_user_group.ml_qa_client_wait_hook(in
qq varchar(128),
2: in waitInSeconds integer)
3: begin
4: declare delay_str varchar(256);
5: if waitInSeconds >= 60*60 then
6: set delay_str=‘1:0:0’
7: elseif waitInSeconds > 59 then
8: set delay_str=‘0:’+cast((waitInSeconds/60) as varchar(256))+‘:’+
9: cast(mod(waitInSeconds,60) as varchar(256))
10: else
11: set delay_str=‘0:0:’+cast(waitInSeconds as varchar(256))
12: end if;
13: waitfor delay delay_str check every 100
14: end

At step 9, when the application 510 calls an API to get a message from queue “q”, a message object is returned. Alternatively, if there is an active message listener on queue “q”, a message object is returned to the application 510 in the message listener callback function. The following are the SQL statements used to get the message and delivery information from the message store (i.e., Message Store 520):

1: SELECT seqno, msgid, address, originator, status, statustime,
verbiage, expires, priority, props, kind, content, contentsize,
syncstatus, receiverid
FROM ml_qa_user_group.ml_qa_messages_client
WHERE msgid = ?
2:
3: SELECT props FROM
ml_qa_user_group.ml_qa_messages_client
WHERE msgid = ?
4:
5: SELECT content FROM
ml_qa_user_group.ml_qa_messages_client
WHERE msgid = ?
6:
7: SELECT msgid, seqno, content FROM
ml_qa_user_group.ml_qa_repository_content_client
WHERE msgid = ?
8:
9: SELECT content FROM
ml_qa_user_group.ml_qa_repository_content_client
WHERE msgid = ?
10:
11: SELECT msgid, name, value FROM
ml_qa_user_group.ml_qa_repository_props_client WHERE msgid = ?
12:
13: SELECT msgid, address, target, status, statustime, verbiage,
syncstatus, receiverid FROM
ml_qa_user_group.ml_qa_delivery_client
WHERE msgid = ?

As a result of the foregoing operations, the message sent from a first mobile device with message store ID “A” is delivered to the queue “q” of the message store with the ID “B” at a second mobile device. The message may then be removed from the queue “q” and provided to an application (e.g., application 510 as shown at FIG. 5) based on logic implemented at the second mobile device. Note that the first mobile device and the second mobile device do not need to connect to the central server at the same time. The message sent by the first device is retained in the central message store (consolidated database) until the second device synchronizes with the central server. The methodology of the present invention for synchronization of client mobile devices with a central server and the application of transmission rules for selecting messages to be exchanged during synchronization will next be described.

Synchronization Scripts and Synchronization Hooks

QAnywhere messaging methodology of the present invention is implemented in synchronization scripts in the consolidated database, and synchronization hooks in the client message store. The synchronization scripts and hooks provide synchronization logic, which may be implemented as individual statements or stored procedure calls. During synchronization, the MobiLink synchronization server reads the synchronization scripts and executes them against the consolidated database. Scripts and hooks provide users with opportunities to perform tasks at various points of time during the synchronization process. Before describing these synchronization scripts and hooks in more detail, the general process of synchronizing a mobile device with a server will be described.

Overview of Synchronization Process

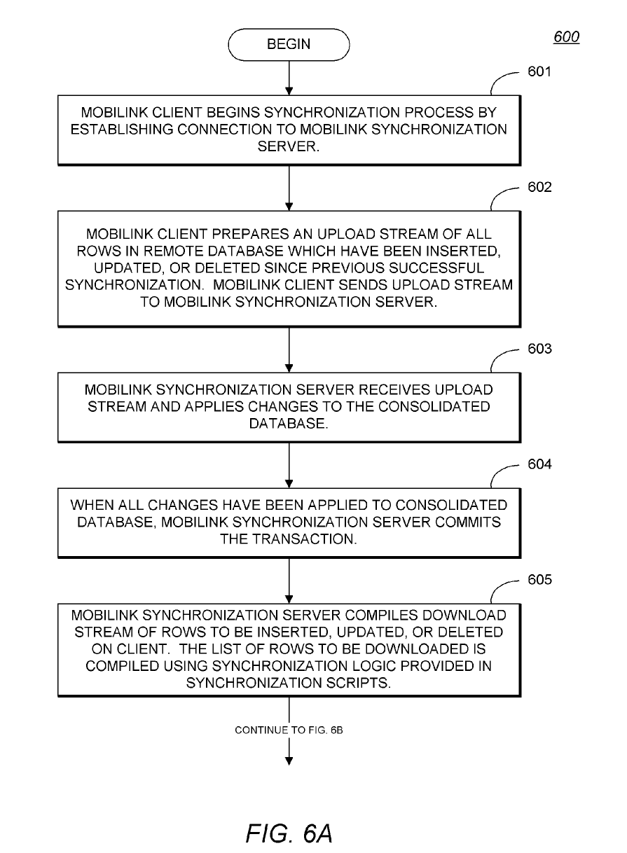

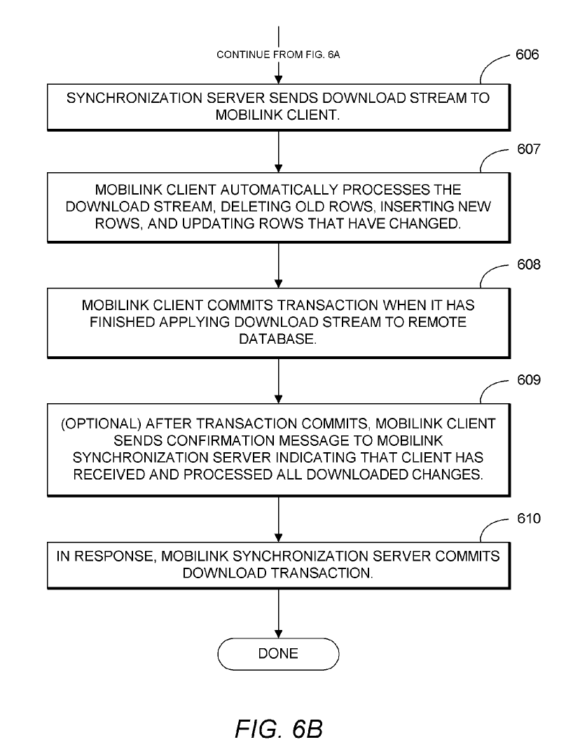

A synchronization is the process of bidirectional data exchange between a MobiLink client and the MobiLink synchronization server. FIGS. 6A-B comprise a single high-level flowchart 600 illustrating the process of synchronization of a client (or remote) database with a server-side consolidated database. Note that the following describes the general synchronization process without the application of transmission rules and other logic for customizing what messages (and/or other information) is exchanged during a particular synchronization session. During the synchronization process, the client must establish and maintain a connection to the synchronization server. If successful, the session leaves the remote and consolidated databases in a mutually consistent state.

A MobiLink client at a mobile device normally initiates the synchronization process. At step 601, the MobiLink client begins the synchronization process by establishing a connection to the MobiLink synchronization server. The upload phase of synchronization then begins. Generally, in the upload phase the MobiLink client prepares and sends an “upload stream” that contains a list of all the rows that have been updated, inserted, or deleted on the MobiLink client since the last synchronization. In the download phase, the MobiLink synchronization server prepares and sends a “download stream” that contains a list of inserts, updates, and deletes at the consolidated database that are to be applied at the client. The upload and download phases of a synchronization session are described in more detail below.

The MobiLink client automatically keeps track of which rows in the remote database have been inserted, updated, or deleted since the previous successful synchronization. Once the connection is established, the MobiLink client uploads a list of all these changes to the synchronization server at step 602. The upload stream consists of a set of new and old row values for each row modified in the remote database. If a row has been updated or deleted, the old values are those that were present immediately following the last successful synchronization. If a row has been inserted or updated, the new values are the current row values. No intermediate values are sent, even if the row was modified several times before arriving at its current state. At step 603, the MobiLink synchronization server receives the upload stream and applies the changes to the consolidated database. It normally applies all the changes in a single transaction. When it has finished, the MobiLink synchronization server commits the transaction at step 604.

In the download phase of synchronization, the MobiLink synchronization server compiles a list of rows to be inserted, updated, or deleted on the MobiLink client at step 605. The list of rows to be downloaded is compiled using synchronization logic provided in synchronization scripts. At step 606, these rows are then downloaded to the MobiLink client. To compile this list, the MobiLink synchronization server opens a new transaction on the consolidated database. When the MobiLink client receives the download stream, it considers the arrival of this stream as confirmation that the consolidated database has successfully applied all uploaded changes. The MobiLink client takes steps to ensure that these changes are not sent to the consolidated database again. At step 607, the MobiLink client automatically processes the download stream, deleting old rows, inserting new rows, and updating rows that have changed. It applies all these changes in a single transaction in the remote database. When finished, it commits the transaction at step 608.

When the transaction has committed, the MobiLink client optionally sends a short confirmation message to the MobiLink synchronization server at step 609. This message tells the synchronization server that the client has received and processed all downloaded changes. In response, the synchronization server commits the download transaction at step 610. It should be noted that there are only a few distinct exchanges of information during a MobiLink synchronization session. The client builds and uploads the entire upload stream. In response, the synchronization server builds and downloads the entire download stream. Limiting the chattiness of the protocol is especially important when communication is slower and has higher latency, as is the case when using telephone lines or public wireless networks.

MobiLink Events During Synchronization

When a synchronization request occurs and a MobiLink server decides that a new connection must be created, a “begin_connection” event is fired and synchronization starts. Following the synchronization, the connection is placed in a connection pool, and MobiLink again waits for a synchronization request for the current script version. Before a connection is eventually dropped from the connection pool, an “end_connection” event is fired. But if another synchronization request for the same version is received, then MobiLink handles the next synchronization request on the same connection. There are a number of events that affect the current synchronization. The primary phases of a synchronization are the upload and download transactions. The events contained in the upload and download transactions are outlined below.

The upload transaction applies changes uploaded from a remote database. The “begin_upload” event marks the beginning of the upload transaction. The upload transaction is a two-part process. First, inserts and updates are uploaded for all remote tables, and second, deletes are uploaded for all remote tables. An “end_upload” event marks the end of the upload transaction. The download transaction fetches rows from the consolidated database. It begins with a “begin_download” event. The download transaction is also a two-part process. For each table, first deletes are downloaded, and then update/insert rows (upserts) are downloaded. An “end_download” event ends the download transaction.

The following pseudocode provides an overview of the sequence in which events, and hence the script of the same name, are invoked. The following pseudocode shows the complete MobiLink synchronization event model and assumes a full synchronization (i.e., not upload-only or download-only) with no errors:

1: Legend:
2: - // This is a comment
3: - <name>
4: The pseudo code for <name> is listed separately
5: in a later section, under a banner:
6. ------------------------
7: name
8. ------------------------
9: - VariableName <- value
10: Assign the given value to the given variable name.
11: Variable names are in mixed case.
12: - event_name
13: If you have defined a script for the given event name,
14: it will be invoked.
15: ------------------------------------------------------
16: CONNECT to consolidated database
17: begin_connection_autocommit
18: begin_connection
19: COMMIT
20: for each synchronization request with
21: the same script version {
22: <synchronize>
23: }
24: end_connection
25: COMMIT
26: DISCONNECT from consolidated database
27: ------------------------------------------------------
28: synchronize
29: ------------------------------------------------------
30:
31: <authenticate>
32: <begin_synchronization>
33: <upload>
34: <prepare_for_download>
35: <download>
36: <end_synchronization>
37: ------------------------------------------------------
38: authenticate
39: ------------------------------------------------------
40:
41: Status <- 1000
42: UseDefaultAuthentication <- TRUE
43: if( authenticate_user script is defined ) {
44: UseDefaultAuthentication <- FALSE
45: TempStatus <- authenticate_user
46: if( TempStatus > Status ) {
47: Status <- TempStatus
48: }
49: }
50: if( authenticate_user_hashed script is defined ) {
51: UseDefaultAuthentication <- FALSE
52: TempStatus <- authenticate_user_hashed
53: if( TempStatus > Status ) {
54: Status <- TempStatus
55: }
56: }
57: if( UseDefaultAuthentication ) {
58: if( the user exists in the ml_user table ) {
59: if( ml_user.hashed_password column is not NULL ) {
60: if( password matches ml_user.hashed_password ) {
61: Status <- 1000
62: } else {
63: Status <- 4000
64: }
65: } else {
66: Status <- 1000
67: }
68: } else if( −zu+ was on the command line ) {
69: Status <- 1000
70: } else {
71: Status <- 4000
72: }
73: }
74: if( Status <= 2000 ) {
75: if( authenticate_parameters script is defined )
76: {
77: TempStatus <- authenticate_parameters
78: if( TempStatus > Status ) {
79: Status <- TempStatus
80: }
81: }
82: if( Status >= 3000 ) {
83: ROLLBACK
84: // Abort the synchronization.
85: } else {
86: // UserName defaults to MobiLink user name
87: // sent from the remote.
88: if( modify_user script is defined ) {
89: UserName <- modify_user
90: // The new value of UserName is later passed to
91: // all scripts that expect the MobiLink user name.
92: }
93: COMMIT
94: }
95: ------------------------------------------------------
96: begin_synchronization
97: ------------------------------------------------------
98:
99: begin_synchronization // conection event
100: for each table being synchronized {
101: begin_synchronization // call the table level script
102: }
103: for each publication being synchronized {
104: begin_publication
105: }
106: COMMIT
107: ------------------------------------------------------
108: end_synchronization
109: ------------------------------------------------------
110:
111: for each publication being synchronized {
112: if( begin_publication script was called ) {
113: end_publication
114: }
115: }
116: for each table being synchronized {
117: if( begin_synchronization table script was called ) {
118: end_synchronization // table event
119: }
120: }
121: end_synchronization // connection event
122:
123: for each table being synchronized {
124: synchronization_statistics // table event
125: }
126: synchronization_statistics // connection event
127: for each table being synchronized {
128: time_statistics // table event
129: }
130: time_statistics // connection event
131:
132: COMMIT

As illustrated above, the synchronization process is composed of multiple steps, with a unique “event name” identifying each step. The COMMIT statements illustrate how the synchronization process is broken up into distinct transactions. The synchronization process can be controlled and customized through the provision of scripts (e.g., scripts written by a user) which are associated with one or more of these events. A user can write a script to provide for some particular action to occur based on a particular event. The MobiLink synchronization server executes each script when its associated event occurs. In most cases, if a script is not defined for a given event, the default action is to do nothing. In other words, if a script is not defined for a particular event, the MobiLink synchronization server simply proceeds to the next step. For example, one event is beginning the process of uploading rows from a mobile device to the server (which has an event name of “begin_upload_rows”). A user can write a script and associate it with this event. The MobiLink synchronization server reads the script when it is first needed, and executes it during the upload phase of synchronization. If no script is supplied, the MobiLink synchronization server proceeds immediately to the next step, which is processing the uploaded rows.

The “begin_connection” and “end_connection” events are connection-level events which are independent of any single synchronization and have no parameters. Some scripts, called “table scripts”, are associated not only with an event, but also with a particular table. The MobiLink synchronization server performs some tasks on a table-by-table basis; for example, downloading rows. A user can have many scripts associated with the same event, each with different application tables. Alternatively, a user can define many scripts for some application tables, but none for other tables. The synchronization system provides many events that a user can exploit, but it is not mandatory that a user provide scripts for each event. Some events, such as “begin_synchronization”, occur at both the connection level and the table level. A user can supply both connection and table scripts for these events. In a simple synchronization model, only a few scripts may be needed.

For example, consider a simple case in which a user wants to provide for downloading all the rows from a particular product table (ULProduct table) to each remote database. In this case, assume that no additions are permitted at the remote databases. This is a simple form of synchronization which can be implemented with a single script associated with one event. The MobiLink event that controls the rows to be downloaded during each synchronization is named the “download_cursor” event. Cursor scripts contain SELECT statements. The MobiLink synchronization server uses these queries to define a cursor. In the case of a download_cursor script, the cursor selects the rows to be downloaded to a particular table in the remote database. In this example application, there is a single download_cursor script for the ULProduct table, which consists of the following query:
1: SELECT prod_id, price, prod_name
2: FROM ULProduct

This query generates a result set. The rows that make up this result set are downloaded to the client. The MobiLink synchronization server knows to send the rows to a particular table (e.g., ULProduct application table) because this script is associated with both the download_cursor event and the ULProduct table by the way it is stored in the consolidated database. The above is a simple example, and a user can write more complicated synchronization scripts. For example, a user can write a script that downloads only recently modified rows, or one that provides different information to each remote database.

Writing Synchronization Scripts

MobiLink synchronization scripts can be written in various languages, including SQL, Java, or .NET. Program synchronization logic can function in the same manner as SQL logic functions. The MobiLink synchronization server can make calls to Java or NET methods on the occurrence of MobiLink events just as it can access SQL scripts on the occurrence of MobiLink events. However, the upload and download streams are not directly accessible from Java or .NET synchronization logic, where a SQL string must be returned to MobiLink.

The synchronization process can be customized or configured by a user on both the client and the server through synchronization scripts and synchronization hooks. On the server, writing synchronization scripts essentially comprises writing a set of event handlers for taking action in response to various events (e.g., to determine what messages are uploaded to the server message store in particular circumstances). The following illustrates some basic QAnywhere consolidated synchronization scripts for synchronizing messages in the consolidated database.

As described above, a synchronization session is initiated by a client (mobile device) and consists of two main phases which are referred to as the upload phase and the download phase. In the first stage, an upload of any rows that have changed (or have been inserted) is performed to upload these changes and inserts from the client to the server. In the context of messages, the upload phase includes uploading messages from message queues of the client message store to the consolidated store at the server. A user can write and supply scripts at the server specifying how the messages from client mobile devices are to be incorporated into the consolidated message store at the server. The scripts essentially comprise event handlers for determining how to handle uploaded messages in various circumstances. The four synchronization scripts below are examples of scripts for inserting particular rows from a remote database (i.e., a message store of a mobile device) into tables of the consolidated database server.

upload_insert event for table ml_qa_global_props_client:
1: insert into ml_qa_global_props(client, name, modifiers, value)
2: values (@ml_username, ?, ?, ?)

upload_update event for table ml_qa_global_props_client:
1: update ml_qa_global_props set modifiers=?, value=? where client=@ml_username and name=?

upload_insert event for table ml_qa_repository_client:
1: insert into dbo.ml_qa_repository(seqno, msgid, originator,priority, expires, props, kind, content, contentsize)

upload_insert event for table ml_qa_delivery_client:
1: insert into ml_qa_delivery(msgid, address, client, status, statustime, verbiage, syncstatus)
2: values (?, ?,?, ?, ?, ?,0)

After the upload has been completed and committed, the second phase commences to download data (i.e., messages) from the server to the client. In this phase, rows that have been changed on the consolidated database are downloaded to the client mobile device. For example, rows that have changed since the last synchronization have been performed may be downloaded to the client. The scripts illustrated below are download scripts which provide for selecting rows of the consolidated database to be downloaded to a client mobile device.

download_cursor event for table ml_qa_global_props_client:
1: select gp.name, gp.modifiers, gp.value from dbo.ml_qa_global_props gp
2: where gp.last_modified >=? and gp.client=?

download_cursor event for table ml_qa_repository_client:
1: select mr.seqno, mr.msgid, mr.originator, mr.priority, mr.expires, mr.props, mr.kind, mr.content, mr.contentsize from dbo.ml_qa_messages mr
2: where ? is not null and mr.syncstatus=3 and mr.status=1 and mr.client=?

download_cursor event for table ml_qa_delivery_client:
1: select t.msgid, t.address, t.client, t.status, t.statustime, t.verbiage from dbo.ml_qa_messages t
2: where ? is not null and t.syncstatus =3 and t.client =?

It should be noted that the above are basic scripts and do not reflect the application of customized transmission rules which may be specified by a user for specifying messages to be uploaded and/or downloaded in particular circumstances. In typical operation the particular messages that are uploaded and downloaded during a given synchronization session may not represent all messages (or other changes) made since the last synchronization was performed. Client-side and server-side transmission rules may provide that only certain messages are to be uploaded and/or downloaded during a particular synchronization session. The transmission rules may, for example, provide for only high priority messages to be uploaded or downloaded if the client has a wireless connection to the server. As another example, the transmission rules may provide that only messages which are smaller than a certain size (e.g., less than 10K) are to be sent in particular circumstances.

QAnywhere Client Synchronization Hooks

The synchronization client, dbmisync, provides a set of event hooks (or synchronization hooks) that can be used to customize the synchronization process. When a hook is implemented, it is called at a specific point in the synchronization process. An event hook is implemented by creating a stored procedure with a specific name. Most event-hook stored procedures are executed on the same connection as the synchronization itself. Event hooks can be used to log synchronization events, schedule synchronizations based on logical events or time, and customize synchronization behavior. In addition, event hooks can be used to synchronize subsets of data that cannot be easily defined in a publication. For example, one can synchronize data in a temporary table by writing one event hook procedure to copy data from the temporary table to a permanent table prior to the synchronization and another to copy the data back afterwards.

The following pseudocode shows the available events and the point at which each is called during the synchronization process:

1:
2: sp_hook_dbmlsync_abort
3: sp_hook_dbmlsync_set_extended_options
4: loop until return codes direct otherwise (
5: sp_hook_dbmlsync_abort
6: sp_hook_dbmlsync_delay
7: )
8: sp_hook_dbmlsync_abort
9: // start synchronization
10: sp_hook_dbmlsync_begin
11: // upload events
12: for each upload segment
13: // a normal synchronization has one upload segment
14: // a transaction-level upload has one segment per transaction
15: // an incremental upload has one segment per upload piece
16: sp_hook_dbmlsync_logscan_begin
17: sp_hook_dbmlsync_logscan_end
18: sp_hook_dbmlsync_upload_begin
19: sp_hook_dbmlsync_upload_end
20: next upload event// download events
21: sp_hook_dbmlsync_validate_download_file (only called
22: when -ba option is used)
23: sp_hook_dbmlsync_download_begin
24: for each table
25: sp_hook_dbmlsync_download_table_begin
26: sp_hook_dbmlsync_download_table_end
27: next table
28: sp_hook_dbmlsync_download_end
29: sp_hook_dbmlsync_schema_upgrade
30: // end synchronization
31: sp_hook_dbmlsync_end
32: sp_hook_dbmlsync_process_return_code
33: sp_hook_dbmlsync_log_rescanError handling

As illustrated above, sp_hook_dbmisync_abort is the first event hook to be invoked. Although the above sequence has similarities to the event sequence at the MobiLink synchronization server, there is little overlap in the kind of logic a user would typically want to add to the consolidated and remote databases. The two interfaces are therefore separate and distinct. Any *_end hook will be called if the corresponding *_begin hook is called and completed successfully. A *_begin hook is considered to have run successfully if it was not implemented when it would have been called. Additional event-hook procedures (not illustrated above) are also available for error handling.

Each event makes particular parameter values available, which can be used in implementing the procedure. In some cases, one can modify the value to return a new value; others are read-only. These parameters are not stored procedure arguments. No arguments are passed to any of the event-hook stored procedures. Instead, arguments are exchanged by reading and modifying rows in a “#hook_dict” table. For example, the “sp_hook_dbmisync_begin” procedure has a parameter, which is the user name that the application supplied in the synchronization call. This value can be retrieved from the #hook_dict table.

The following pseudocode illustrates some basic client synchronization hooks provided in the currently preferred embodiment of the present invention.

```
  1: sp_hook_dbmlsync_logscan_begin:
  2:
  3: for (priority 9 .. 1) {
  4:  mark pending rows in ml_qa_repository_client that need to be
synchronized
  5:  mark pending rows in ml_qa_delivery_client that need to be
synchronized
  6: commit transaction
}
```

The sp_hook_dbmisync_logscan_begin happens fairly early in the synchronization process for determining and marking rows of the client message store that are to be uploaded to the server. As shown, these rows are determined based on a priority assigned to the messages. Generally, a set of transactions are constructed in a manner such that rows corresponding to higher priority messages will be committed on the server earlier than lower priority messages under some circumstances.

The following connect failed hook (sp_hook_dbmisync_mi_connect_failed) illustrates a fail-over capability provided in the currently preferred embodiment of the present invention:

1: sp_hook_dbmlsync_ml_connect_failed:
2: if (there are alternative servers defined) {
3: set output parameters to retry next alternate server in list
4: delay}

The QAnywhere Agent on the client is able to perform synchronizations with alternate MobiLink synchronization servers in the event that the primary is unreachable for some reason (e.g., network connectivity or availability). In the event the primary is unreachable, alternative servers are tried until one is reached or the attempts fail.

The following sp_hook_dbmisync_upload_end hook happens at the end of the upload phase of synchronization:

1: sp_hook_dbmlsync_upload_end:
2: if (upload was committed) {
3: set all marked rows in ml_qa_repository_client to ‘synchronized’
4: set all marked rows in ml_qa_delivery_client to ‘synchronized’
5: }

As shown above, all rows that were uploaded during the session are marked with a particular status to indicate that they have been uploaded or synchronized. The sp_hook_dbmisync_end hook illustrated below occurs fairly late during a synchronization session after the download phase has been received:

1: sp_hook_dbmlsync_end:
2: if (download failed and can be restarted) {
3: set output parameters to restart the download
4: set sync_flag to a fixed delay
5: } else if (synchronization succeeded or policy is “scheduled”) {
6: clear sync_flag
7: signal client library threads that are waiting for messages
8: } else {
9: set sync_flag to delay 2*(the previous delay)
10: }

As shown, the determination is made as to whether the download succeeded. If the download failed, a “restartable download” feature of the QAnywhere messaging system provides for restarting a download that was incomplete. For example, a download that is in process may be interrupted because of network connectivity problems. In the event a download is interrupted, a flag is set so that the download can be restarted from where it left off, thereby possibly avoiding the need to restart the download from the beginning. If the synchronization. succeeded or if the policy is “scheduled” (meaning that synchronization sessions are to be performed at periodic intervals), the sync_flag is cleared so that the QA Agent knows that it has to perform another synchronization At the end of a synchronization session, application client library threads which are waiting for messages are also signaled to indicate that they can now receive messages. Also, in the event that the synchronization fails, the system provides for trying again to synchronize at an exponentially increasing time interval.

QAnywhere Agent

Prior art messaging solutions typically require an application to be running in order for messages to (and from) the application to move back and forth between client and server. For example, an application may start running on a client mobile device and generate messages which are (assuming the application is then connected) sent to the server. The present invention provides a QA Agent which is a separate process independent of the application. When an application at a client mobile device sends a message, the present invention queues the message in the client message store. The QA Agent then operates as a background process to deliver the message to the consolidated message store (database) at the server when conditions are suitable for transmitting messages (e.g., when connectivity has been established). The QA Agent operates to deliver and receive messages, even if the application that is the source or target of a given message is not running at the time the message is delivered by, or received at, the mobile device.

The following is a high-level pseudocode description of the operations of the QAnywhere Agent when the Agent is started on a client device:

1: Parse command line parameters
2: Connect to message store (it will be autostarted if it is not already
running)
3: If -si was specified
4: Initialize the message store with the QAnywhere schema and terminate
5: If -su was specified
6: Upgrade the QAnywhere schema as appropriate and terminate
7: Set QAnywhere Agent parameters in message store from command line
options
8: If -policy is a file of transmission rules
9: Compile transmission rules file //(see pseudo-code snippet below)
10: Launch dbmlsync
11: Launch the Synchronization Event Thread
12: Launch the Listener Agent Thread
13: If dblsn is running
14: Register with dblsn to receive notifications
15: Else
16: Launch dblsn
17: Wait for shutdown
18: Stop Listener Agent Thread
19: Stop dblsn if it was launched by us
20: Stop the Synchronization Event Thread
21: Stop dbmlsync
22: Exit

As shown above at lines 1-2, the Agent initially parses command line parameters (if applicable) and connects to the client message store. The client message store (database) is autostarted if it is not already running. The -si option provides for initializing the message store with the QAnywhere schema (described above). The -su option provides for updating the QAnywhere schema (e.g., to support customers moving forward with new releases). The Agent also processes any command line options. For example, one command line option provides for a user is to specify the network protocol that is to be used (e.g., TCP/IP or HTTP), the host name, and port for communication.

Another option is the -policy option as illustrated above at line 8. The -policy option enables a user to specify policies that are to be used for message transmissions. As previously described, three pre-defined policies are provided by default for regulating the flow of messages between client and server: “ondemand”, “scheduled”, and “automatic”. Additionally, a user may specify a custom policy which provides for the transmission of messages to be governed by a specified set of transmission rules. A user can write transmission rules to specify when particular types of messages are to be sent or received. The user specifies the transmission rule file to be used on the command line and the system compiles and applies the transmission rules provided in the transmission rule file as hereinafter described.

Next, the Agent launches dbmisync, which is the MobiLink synchronization client, as shown above at line 10. The Agent also starts a synchronization event thread and a listener agent thread. The synchronization event thread is for controlling synchronizations as the Agent is running. It signals dbmisync when a synchronization needs to be performed. The listener agent thread controls communication with dbisn (the listener agent), a component which listens for notifications from the server (e.g., indicating messages are waiting on the server) and also monitors network connectivity (device tracking) as previously described. If dbisn is already running, the QA Agent registers to receive notifications. Otherwise, dbisn is launched.

After the above steps, the QA Agent enters a steady state in which it takes action in response to events. The listener agent thread and synchronization event thread may cause events to happen. Subsequently, when the QA Agent is shutdown, the Agent shuts everything down in the reverse order (i.e., the reverse of the order in which they were started) and exits as shown above at lines 18-22.

Synchronization Event Thread

The following is a pseudocode description of the synchronization event thread:

```
  1: While not done
  2:  ShouldWait = ml_qa_wait_hook( ) // see pseudo-code
snippet in next section
  3:  If not ShouldWait
  4:  Signal dbmlsync to perform a synchronization
```

The synchronization event thread enters a loop and calls a stored procedure (described below) in the message store to determine whether or not it should signal dbmisync to perform a synchronization. If it decides not to signal dbmisync to perform a synchronization, it waits a specified time interval and then calls the stored procedure again.

Listener Agent Thread

The following is a pseudocode description of the listener agent thread:

1: While running
2: Accept connection from dblsn
3: When connection accepted
4: Receive buffer from dblsn
5: If buffer starts with “[qa]”
6: // push notification
7: set sync_flag to indicate push notification
8: send message to “system” queue
9: else if buffer starts with “[netstat]”
10: // network status notification
11: set sync_flag to indicate network status notification
12: send message to “system” queue

As shown, the listener agent thread goes into a loop and accepts a connection request from dbisn through a socket (e.g., currently using a TCP/IP connection for interprocess communication on the client device). The listener agent thread will receive one of two things from dbisn from time to time: a push notification, or a network status notification. The “push” notification indicates that there are messages waiting on the server to be sent down to this mobile device. In response, a “sync_flag” is set in the message store so that the QA Agent can process it. Also, a message is sent to a “system” queue to indicate that a push notification has been received. The user may provide logic for specifying how the push notification is to be handled by an application. The network status notification message indicates that some change has occurred in network connectivity (e.g., going out of coverage and losing network connectivity).

Standard Transmission Policies

The following pseudocode describes the ml_qa_wait_hook( ) which contains the transmission policy logic for standard transmission policies provided in the currently preferred embodiment of the present invention:

1: if (policy is “automatic” or “ondemand”) {
2: if (policy is “automatic” and
3: (sync_flag indicates push notification received or
4: triggerSendReceive( ) called or
5: scheduled synchronization or
6: status notification received)) {
7: shouldWait = false;
8: } else if (sync_flag indicates triggerSend( ) called and
9: ml_qa_has_messages_to_upload( )) {
10: shouldWait = false;
11: } else if (sync_flag indicates triggerSendReceive( ) called) {
12: shouldWait = false;
13: } else if (policy is “automatic” and
14: (sync_flag indicates network status notification received or
15: message store has been updated) and
16: (ml_qa_has_messages_to_upload( ))) {
17: shouldWait = false;
18: } else if (policy is “automatic” and
19: (sync_flag indicates delayed synchronization)) {
20: waitfor 2*(delay from sync_flag);
21: shouldWait = false;
22: } else {
23: shouldWait = true;
24: }
25: } else if (policy is “scheduled”) {
26: if (sync_flag indicates push notification received or
27: triggerSendReceive( ) called or
28: scheduled synchronization or
29: status notification received) {
30: shouldWait = false;
31: } else if (sync_flag indicates triggerSend( ) called and
32: ml_qa_has_messages_to_upload( )) {
33: shouldWait = false;
34: } else {
35: shouldWait = true;
36: }
37: } else {
38: shouldWait = true;
39: }
40: if (shouldWait) {
41: waitfor (fixed delay);
42: }
43: return shouldWait;

The above ml_qa_wait_hook( ) stored procedure includes the main transmission policy logic for implementing transmission policies. It also provides a hook into the transmission rules engine. The ml_qa_wait_hook( ) procedure is called in the above_described synchronization event thread periodically by the QA Agent. It first checks what policy it is running under (e.g., “automatic”, “ondemand”, or “scheduled”). The scheduled policy provides that a synchronization should be performed if the specified time interval has elapsed. For example, the policy provides for scheduling a synchronization every 30 seconds, then a synchronization needs to be performed if 30 seconds has elapsed. A synchronization may also be triggered if a “triggerSendReceive” is called by a client application (i.e., in the event the client application decided to trigger a message transmission) to override the schedule.

The top part of the above procedure handles the case in which an automatic or an ondemand policy is specified. As shown, a number of these cases apply only if an automatic policy is in effect. If the policy is ondemand and “triggerSendReceive” is called, “shouldWait” is set to false to indicate that a synchronization should be performed. This is the only case in which a synchronization should occur if the user has specified an “ondemand” policy. The other cases in the top half of the above pseudocode apply in the event of an “automatic” policy. If an automatic policy is in effect, a number of events may cause a synchronization. session to be initiated, including a push notification, a “triggerSendReceive” command, receipt of a status notification, or a scheduled interval specified in transmission rules has passed.

The following ml_qa_has_messages_to_upload method is called in the above stored procedure for determining whether there are, in fact, messages in the client message store to upload to the server.

1: select count(*) into cnt from ml_qa_delivery_client md
2: where syncstatus = 0
3: and status >= 20
4: and target is not null and target <> uu;
5: if cnt > 0 then
6: return 1;
7: end if;
8: select count(*) into cnt from ml_qa_messages_client mr
9: where syncstatus = 0
10: and status = 1
11: and target is not null and target <> uu
12: and ml_qa_evaluate_xmit_rules( mr.msgid ) = 1;
13: if cnt > 0 then
14: return 1;
15: else
16: return 0;
17: end if;

The above method checks the message repository (message store) to determine if there are messages destined for the server or another mobile client device that have not yet been uploaded to the server. It should be noted that the message store may also include messages that are targeted to this local message store. These local messages do not need to be synchronized to the server. An optimization provided by the present invention enables another application on the same client device to receive a message from the message store without the message being synchronized to the server. As also shown above at line 12, the call to ml_qa_evaluate_xmit_rules provides a link into the transmission rules engine. The transmission rules engine and the evaluation of transmission rules is described below.

Transmission Rules Engine

The transmission rules engine uses a conditional language syntax (e.g., like C++, Java, or the like) that is similar to SQL and uses some of the same rules as SQL. It allows a user (e.g., developer or administrator) to create conditions for rule delivery that are based on properties of a message, such as the priority of the message, the address of the message, the size of the message, as well as user-configurable properties of the message. For instance, a user could define a custom “very important” property and a rule could provide for taking action based on whether or not a message had the “very important” property. A rule can also be based on other factors which are not specific to a message such as time of day (i.e., when the rule is evaluated) as well as the network status of the device on which the rules are evaluated (client or server). The network status may be based on what type of network card the device is currently using (e.g., a wireless card, a LAN card, etc.).

Generally, each clause or rule of a transmission policy is evaluated separately for each message. If any clause evaluates to true, then the message is considered to be deliverable (or synchronizable). For example, a rule may be provided for messages with a size that is less than 10,000 bytes. If a message had a size of 5,000 bytes, it would be marked as deliverable (synchronizable). However, if a message had a size of 250,000 bytes, it would not be deliverable based on the rule.

Currently, the language used for rule evaluation is SQL. Evaluation of rules involves taking the transmission policy specified by the user and included in a particular file (i.e., a transmission rule file indicated by the user on the command line as previously described. The transmission rules engine is a “compiler” of transmission rules into SQL events that determine the synchronization logic for the QAnywhere schema. The following is a pseudo-code description of the transmission rules compilation process.

1: SyncRuleSchemaCreator syncRuleMgr;
2: For each transmission rule in rules file
3: Parse it into schedule SQL and condition SQL;
4: syncRuleMgr.createRule( schedule SQL, condition SQL );
5: syncRuleMgr.completeRules( );

As shown above, each of the transmission rules in the file is parsed (e.g., using a conventional parser) to verify and understand the structure of each of the rules. The parsed tree is then unparsed (or recombined) into SQL form and compiled down into a stored procedure that is added to the database (e.g., client message store database or consolidated database). One reason for parsing the rule file is to verify that the syntax of the rules specified by the user is correct, so as to avoid runtime errors. Another reason for doing so is to extract certain information from the messages so that additional processing can be performed based on the conditions indicated in the transmission rules.

Most of the message properties on which rules are typically based (e.g., message priority, message address, message size, and so forth) are easily mappable to tables and columns of the message store database. For example, the above rule looking at whether size of a message is less than 10,000 bytes is compiled into a SELECT statement on the “content.size” column message table which indicates the size of the message. However, a more complex situation involves an arbitrary message property that may be specified by a user such as, for example, the custom “very important” property described above. When a message is created, a row is output to a supplementary table (i.e., the ml_qa_repository_props_client table as described in the above schema) with the name of the property, the value of the property, and the message id which maps it to the originating message. When a condition relies on (or references) one of these values, that reference is transformed into a subselect (or subquery), comprising a SELECT statement embedded into another (existing) SELECT statement. A subselect specifies a result table derived from the tables or views identified in the FROM clause. The derivation can be described as a sequence of operations in which the result of each operation is input for the next. (This is only one way of describing the subselect. The method used to perform the derivation may be quite different from this description.) For each of those property references, a subselect is embedded to reference the message properties properties table using the message id of the current message.

In addition to referencing message properties, transmission rules can also reference global properties, which are properties associated with a message store rather than with a particular message. This also involves creating a subselect (or subquery) on the global properties table which is embedded in a SELECT statement on the message repository table. Among the global properties that are currently maintained is a network status property which indicates the status of the network connection of a device (e.g., a client mobile device). This enables a user to obtain the network status of a device by referencing the global properties.

In addition, a user may specify a network connection by “type”. Typically, a laptop or other mobile device has both a LAN card and a wireless card for network connectivity. A given device may also have other mechanisms for establishing network connectivity. The system of the present invention tracks type of connection (e.g., which of the cards) is being used from time to time. However, the names of these cards are typically vendor-specific and therefore are difficult to use in constructing and evaluating rules of a transmission policy. For example, a LAN card may be named “Intel Gigabit Ethernet XYZ” and a wireless card might be named “GPRS CDEF”. It can be difficult for a user to implement transmission rules using these vendor-specific names. Using these names may also make the rules much less portable from device to device as it would require one to know the exact name of the cards in use on each device. The present invention allows a user to specify a “type” for each network card that maps a particular network card (e.g., “Intel Gigabit Ethernet XYZ”) to a keyword “LAN”. The user can then write rules which simply refer to the network type “LAN” (e.g., “network.type=LAN”) rather than having to specify the particular network card in use using a vendor-specific name.

It should be noted that transmission rules can be constructed and applied in a similar fashion on both client mobile devices and on the server. The same process for parsing and unparsing the rules into SQL is applied. One difference is that on the server, the global properties are actually synchronized up from the mobile clients to the server, enabling the server to know information about the mobile devices. This enables the server to apply transmission rules based on characteristics of the particular client device that is synchronizing with the server. For example, a transmission rule may provide that if the client is using a wireless card to connect with the server, the server should not download messages to the client.

Scheduling rules indicate when the above transmission rules are evaluated. Generally, if a rule is specified, the rule is evaluated anytime a client device establishes connectivity and has an opportunity to synchronize with the consolidated database at the server. Another event that may trigger rule evaluation is when a message is added to the message store. In this case, pending messages are evaluated to determine if there are other messages in the message store than may need to be synchronized. Another event that may trigger transmission policy evaluation is the sending of a notice from the server to the client indicating that messages are available at the server. Usually, receipt of this type of notification from the server will cause the client to evaluate whether it has any messages that need to be uploaded to the server. In addition to the above events, a user can specify a schedule on which transmission rules are to be evaluated. For example, a user can schedule rules to be evaluated on a mobile device on an hourly basis or at a specified day and time (e.g., at 5:00 pm Monday-Friday). Rule evaluation can be scheduled using a scheduling language provided in the currently preferred embodiment of the present invention.

The following is the current interface of the class SyncRuleSchemaCreator:

```
  1: class RuleSchemaCreator: public SchemaCreator {
  2:  public:
  3:  RuleSchemaCreator( SQLCA *sqlca ): SchemaCreator( sqlca ),
  4:  _oldRuleID( 0 ), _oldEventID( 0 ), _ruleID( 0 ), _eventID( 0 )
  5:  {
  6:  }
  7:  public:
  8:  virtual bool cleanupRules( ) = 0;
  9:  virtual bool createRule( const char *schedSql, const char
*conditionSql ) = 0;
10:  virtual bool completeRules( ) = 0;
11: };
12:
13: class SyncRuleSchemaCreator: public RuleSchemaCreator {
14: #define SYNC_EVENT_PREFIX “ml_qa_sync_event_”
15:  public:
16:  SyncRuleSchemaCreator( SQLCA *sqlca ):
      RuleSchemaCreator( sqlca )
17:  {
18:  }
19:  public:
20:  virtual bool cleanupRules( );
21:  virtual bool createRule( const char *schedSql, const char
*conditionSql );
22:  virtual bool completeRules( );
23: };
```

The following pseudocode illustrates the body of the SyncRuleSchemaCreator which provides for setting up the environment so that the rules can be created in a form (e.g., stored procedures) for storage in the database which enables them to be executed during transmission rule evaluation:

```
  1: #define SYNC_RULE_PREFIX “ml_qa_sync_rule_”
  2:
  3: static const char *CREATE_SCHED_SYNC_UNCONDITIONALLY_EVENT =
  4: “schedule %s\n”
  5: “handler\n”
  6: “begin\n”
  7: “ call “ QA_TAB_OWNER ”.ml_qa_update_sync_status(“ _STR(
SYNC_STAT_SCHEDULED ) ”);\n”
  8: “end”;
  9:
  10: static const char *CREATE_SCHED_SYNC_EVENT =
  11: “schedule %s\n”
  12: “handler\n”
  13: “begin\n”
  14: “ call “ QA_TAB_OWNER ”.ml_qa_set_local_property( ‘“
SYNC_EVENT_PREFIX ”%d’, ‘T’ );\n”
  15: “ call “ QA_TAB_OWNER ”.ml_qa_update_sync_status(“ _STR(
SYNC_STAT_SCHEDULED ) ”);\n”
  16: “end”;
  17:
  18: static const char *CREATE_HAS_ROWS_TO_UPLOAD_RULE =
  19: “( in inmsgid “ MSGID_COL_TYPE ” )\n”
  20: “ returns bit\n”
  21: “begin\n”
  22: “ declare cnt int;\n”
  23: “ select count(*) into cnt\n”
  24: “ from “ MSGREPOS_CLIENT_VIEW ” mr\n”
  25: “ where mr.“ MSGID_COL ” = inmsgid and (%s);\n”
  26: “ if cnt = 0 then return 0; else return 1; end if;\n”
  27: “end”;
  28:
  29: static const char *CREATE_HAS_ROWS_TO_UPLOAD_SCHEDULED_RULE =
  30: “( in inmsgid “ MSGID_COL_TYPE ” )\n”
  31: “ returns bit\n”
  32: “begin\n”
  33: “ declare scheduled varchar(127);\n”
  34: “ declare cnt int;\n”
  35: “ select “ PROP_VAL_COL ” into scheduled from “
GLOBAL_PROPS_CLIENT_TABLE ”\n”
  36: “ where “ PROP_NAME_COL ” = ‘“ SYNC_EVENT_PREFIX ”%d’;\n”
  37: “ if scheduled is null or scheduled = ‘F’ then return 0; end if;\n”
  38: “ select count(*) into cnt\n”
  39: “ from “ MSGREPOS_CLIENT_VIEW ” mr\n”
  40: “ where mr.“ MSGID_COL ” = inmsgid and (%s);\n”
  41: “ if cnt = 0 then return 0; else return 1; end if;\n”
  42: “end”;
  43:
  44: bool SyncRuleSchemaCreator::createRule( const char *schedSQL, const
char *condition )
  45:/******************************************************************/
  46: {
  47:  if( schedSQL == NULL && condition == NULL ) {
  48:  return true;
  49:  } else if( schedSQL != NULL && condition == NULL ) {
  50:  bufSize = _scprintf( CREATE_SCHED_SYNC_UNCONDITIONALLY_EVENT,
  schedSQL );
  51:  buf = (char *)ut_alloc( bufSize + 1 );
  52:  sprintf( buf, CREATE_SCHED_SYNC_UNCONDITIONALLY_EVENT, schedSql );
  53:  sprintf( name, SYNC_EVENT_PREFIX “%d”, _eventID );
  54:  /* Create SQL EVENT with name ‘name’ and body ‘buf’ */
  55:  _eventID++;
  56:  return true;
  57:  } else if( schedSQL != NULL ) { // && condition != NULL
  58:  bufSize = _scprintf( CREATE_SCHED_SYNC_EVENT, schedSQL, _eventID
);
  59:  buf = (char *)ut_alloc( bufSize + 1 );
  60:  sprintf( buf, CREATE_SCHED_SYNC_EVENT, schedSql, _eventID );
  61:  sprintf( name, SYNC_EVENT_PREFIX “%d”, _eventID );
  62:  /* Create SQL EVENT with name ‘name’ and body ‘buf’ */
  63:  }
  64:
  65:  buf = (char *)ut_alloc( bufSize + 1 );
  66:  if( schedSql == NULL ) {
  67:  sprintf( buf, CREATE_HAS_ROWS_TO_UPLOAD_RULE, condition );
  68:  } else {
  69:  sprintf( buf, CREATE_HAS_ROWS_TO_UPLOAD_SCHEDULED_RULE,
_eventID++,
  70:  condition );
  71:  }
  72:  sprintf( name, SYNC_RULE_PREFIX “%d”, _ruleID++ );
  73:  /* Create SQL FUNCTION with name ‘name’ and body ‘buf’ */
  74:  return true;
  75: }
  76:
  77: bool SyncRuleSchemaCreator::completeRules( )
  78: /*****************************************/
  79: {
  80:  if( _ruleID == 0 ) {
  81:  if( _oldRuleID > 0 ) {
  82:  /* Create SQL FUNCTION with name “ml_qa_evaluate_xmit_rules”
  83:  and body */
  84:  body = “( msgid “ MSGID_COL_TYPE ” ) returns bit\n”
  85:  “begin\n”
  86:  “ return 1;\n”
  87:  “end”;
  88:  }
  89:  } else if( _ruleID > 0 ) {
  90:  StringBuffer buf;
  91:
  92:  buf.append( “( msgid “ MSGID_COL_TYPE ” ) returns bit\n” );
  93:  buf.append( “begin\n” );
  94:  for( int i = 0; i < _ruleID; i++ ) {
  95:  buf.append( “if ” QA_TAB_OWNER “.” SYNC_RULE_PREFIX );
  96:  buf.append( i );
  97:  buf.append( “(“ MSGID_COL ” )” );
  98:  buf.append( “ = 1 then\nreturn 1;\nend if;\n” );
  99:  }
100:  buf.append( “return 0;\n” );
101:  buf.append( “end” );
102:
103:  body = buf.toString( );
104:
105:  /* Create SQL FUNCTION with name “ml_qa_evaluate_xmit_rules”
106:  and body */
107:  }
108:  return true;
109: }
110:
111: End
```

Sample Transmission Rules

As described above, transmission rules allow users to specify when message transmission is to occur and which messages to transmit. A user can also use them to specify when messages should be deleted from the message stores. Transmission rules can be specified on the server(s) and on the client(s). By default, QAnywhere messages are transmitted every 10 seconds. This behavior can be changed and customized by specifying a transmission rules file as the transmission policy for the QAnywhere Agent. The following examples illustrate the creation and use of transmission rules in the system of the present invention.

The following sample client transmission rules file specifies that during business hours only small high priority messages should be sent, while outside of business hours (e.g., 8:00 AM to 6:00 PM), any message can be sent. This rule is automatic, which indicates that if the condition is satisfied, the message is transmitted immediately. This example demonstrates that conditions can use information derived from the message as well as other information such as the current time.
1: automatic=(ias_ContentSize <100000 and ias_Priority >7)
2: or ias_CurrentDayOfWeek in (‘Saturday’, ‘Sunday’)
3: or ias_CurrentTime <‘8:00 AM’ or ias_CurrentTime >‘6:00 PM’

Server transmission rules govern the behavior of messages going from the server to the client. Server transmission rules are handled by the MobiLink synchronization server. A server transmission rules file can be created and specified within a messaging properties file. Server transmission rules generally must be specified for each client by preceding a section of rules with the client message store ID in square brackets. The following is a sample server transmission rules file. In the following example, the rules apply only to the client identified by the client message store ID sample_store_id.

```
  1: [sample_store_id]
  2: ; This rule governs when messages are transmitted to the client
  3: ; store with id sample_store_id.
  4: ;
  5: ;  ias_Priority >= 7
  6: ;
  7: ; Messages with priority 7 or greater should always be
  8: ; transmitted.
  9: ;
10: ;  ias_ContentSize < 100
11: ;
12: ; Small messages, that is messages less than 100 characters or
13: ; bytes in size, should always be transmitted.
14: ;
15: ;  ias_CurrentTime < ‘8:00am’ or ias_CurrentTime > ‘6:00pm’
16: ;
17: ; Outside of business hours, messages should always be
18: ; transmitted
19:
20: auto = ias_Priority >= 7 or ias_ContentSize < 100 \
21:   or ias_CurrentTime < ‘8:00am’ or ias_CurrentTime > ‘6:00pm’
22: [qanywhere]
23: ; This rule governs when messages are transmitted to the client
24: ; store with id qanywhere.
25: ;
26: ;  tm_Subject not like ‘%non-business%’
27: ;
28: ; Messages with the property tm_Subject set to a value that
29: ; includes the phrase ‘non-business should not be transmitted’
30: ;
31: ;  ias_CurrentTime < ‘8:00am’ or ias_CurrentTime > ‘6:00pm’
32: ;
33: ; Outside of business hours, messages should always be
34: ; transmitted
35:
36: auto = tm_Subject not like ‘%non-business%’ \
37:  or ias_CurrentTime < ‘8:00am’ or ias_CurrentTime > ‘6:00pm
```

Schedules are used to specify times when conditions are to be evaluated. At those times, the corresponding condition is evaluated for all messages ready to be sent. Those messages satisfying the condition are sent at that time. The syntax of each rule is of the following form: schedules=condition. When the scheduled time occurs, the condition is applied to each message. If the message satisfies the condition, then the message is transmitted. Schedules are structured as illustrated below:

1: schedules : { AUTOMATIC | schedule-spec [,...] }
2:
3: schedule-spec :
4: { START TIME start-time | BETWEEN start-time AND end-time }
5: [ EVERY period { HOURS | MINUTES | SECONDS } ]
6: [ ON { ( day-of-week, ...) | (day-of-month, ... ) } ]
7: [ START DATE start-date ]

The AUTOMATIC parameter indicates that conditions are evaluated whenever a message is available for transmitting. Messages that satisfy the corresponding condition are transmitted. Schedule specifications other than AUTOMATIC specify times when conditions are to be evaluated. At those scheduled times, the corresponding condition is evaluated for all messages ready to be transmitted. Those messages satisfying the condition are transmitted at that time. More than one schedule can be created for a given condition, permitting complex schedules to be implemented. A schedule specification is recurring if its definition includes EVERY or ON; if neither of these reserved words is used, the schedule specifies at most a single time. Each time a scheduled time occurs, the associated condition is evaluated and then the next scheduled time and date is calculated. The next scheduled time is computed by inspecting the schedule or schedules, and finding the next schedule time that is in the future.

QAnywhere transmission rule variables are used in condition syntax in transmission rules files. They can be used to define transmission rules and delete rules. There are currently three types of rule variable: message headers, message properties, and message store properties. Each of these are briefly described below.

The Following Message Headers are Pre-Defined:

ias_Address: The address of the message. For example, myclient\myqueue.

ias_Originator: The client message store ID associated with the message sender.

ias_Status: The status of the message. The ias_ExpireState status indicates the message expired before it could be received by the intended recipient. The ias_FinalState status indicates the message is received or expired. Therefore, >=ias_FinalState means that the message is received or expired, and <ias_FinalState means that the message is neither received nor expired. An ias_PendingState status indicates that the message has not yet been received by the intended recipient, while ias_Received indicates the message was received.

ias_StatusTime: The date and time when the message reached the current status.

ias_Expires: The date and time when the message will expire if it is not delivered.

ias_Priority: The priority of message: a number from 0 to 9.

ias_ContentSize: The size of the message content. If the message is a text message, this is the number of characters. If the message is binary, this is the number of bytes.

QAnywhere allows a user to define message store properties using the C++ or .NET QAnywhere APIs. These properties are shared between applications connected to the same message store. They are also synchronized to the server message store so that they are available to the transmission rules used by a QAnywhere Agent connected to the same client message store. Message properties are defined in messages, and then referenced in transmission rules.

The client store properties include pre-defined and user-defined properties. The following provides an example in C# of how client store properties can be used in transmission rules. Assume a user has a Windows laptop that has the following network connectivity options: LAN, Wireless LAN, and Wireless WAN. Access to the network via LAN is provided by a network card named “My LAN Card”. Access to the network via Wireless LAN is provided by a network card named “My Wireless LAN Card”. Access to the network via Wireless WAN is provided by a network card named “My Wireless WAN Card”. A user may want to develop a messaging application that sends all messages to the server when connected using LAN or Wireless LAN and only high priority messages when connected using Wireless WAN. The user defines high priority messages as those whose priority is greater than or equal to 7. A transmission rule may be created on this basis as hereinafter described.

First, the user defines three client store properties for each of the network types: LAN, WLAN, and WWAN. Each of these properties will be assigned a cost attribute. The cost attribute is a value between 1 and 3and represents the cost incurred when using the network. A value of 1 represents the lowest cost.

1: QAManager qa_manager;
2: qa_manager.SetStoreProperty( “LAN.Cost”, “1” );
3: qa_manager.SetStoreProperty( “WLAN.Cost”, “2” );
4: qa_manager.SetStoreProperty( “WWAN.Cost”, “3” );

Next, three client store properties are defined; one for each network card that will be used. The property name should match the network card name. The appropriate network classification is assigned to each property by assigning the network type to the Type attribute. Each property will therefore inherit the attributes of the network types assigned to them.

1: QAManager qa_manager;
2: qa_manager.SetStoreProperty( “My LAN Card.Type”, “LAN” );
3: qa_manager.SetStoreProperty( “My Wireless LAN Card.Type”,
“WLAN” );
4: qa_manager.SetStoreProperty( “My Wireless WAN Card.Type”,
“WWAN” );

When network connectivity is established, QAnywhere will automatically define the Adapter attribute of the ias_Network property to one of “My LAN Card”, “My Wireless LAN Card” or “My Wireless WAN Card”, depending on the network in use. Similarly, it will automatically set the Type attribute of the ias_Network property to one of “My LAN Card”, “My Wireless LAN Card” or “My Wireless WAN Card” so that the ias_Network property will inherit the attributes of the network being used. Finally, a transmission rules file is created with the following transmission rule: ias_Network.Cost <3 or ias_Priority >=7. This transmission rule provides for sending all messages to the server when the device is connected using LAN or Wireless LAN. However, only high priority messages (i.e., those with a priority greater than or equal to 7) are sent when the device is connected to the server using Wireless WAN.

Delete Rules

Delete rules determine the persistence of messages in the client message store and/or the server message store. Delete rules are also specified in transmission rules files. By default, messages are deleted from the client message store when the final status of the message is determined to be received or expired. A user may modify this default behavior by creating a delete section in a client transmission rules file. The following is an example of the delete rules section of a client transmission rules file:

```
  1: [system:delete]
  2:
  3: ; This rule governs when messages are deleted from the client
  4: ; store
  5: ;
  6: ;  start time ‘1:00am’ on ( ‘Sunday’ )
  7: ;
  8: ; Messages are deleted every Sunday at 1:00AM.
  9: ;
10: ;  ias_Status >= ias_FinalState
11: ;
12: ; Typically, messages are deleted when they reach a final
13: ; state: received, unreceivable, expired, or cancelled.
14:
15: start time ‘1:00am’ on ( ‘Sunday’ ) = ias_Status >= ias_FinalState
```

In the currently preferred embodiment of the present invention, server-side delete rules apply to all QAnywhere clients. By default, messages are deleted from the server message store as soon as the message has been delivered and delivery is confirmed. A user wanting to keep messages longer for purposes such as auditing may do so by creating a delete section in a server transmission rules file. The following is an example of the delete rules section in a server transmission rules file:

```
  1: [system:delete]
  2:
  3: ; This rule governs when messages are deleted from the server
  4: ; store
  5: ;
  6: ;  start time ‘1:00am’ on ( ‘Sunday’ )
  7: ;
  8: ; Messages are deleted every Sunday at 1:00AM.
  9: ;
10: ;  ias_Status >= ias_FinalState
11: ;
12: ; Typically messages are deleted when they reach a final
13: ; status: received, unreceivable, expired or cancelled.
14:
15: start time ‘1:00am’ on ( ‘Sunday’ ) = ias_Status >= ias_FinalState
```

Creating QAnywhere Applications and Sending QAnywhere Messages

The following procedures (in C++ programming language unless otherwise indicated) describe how a user can create a simple QAnywhere enabled application that can send messages to (and receive messages from) other QAnywhere applications (e.g., at other devices). The following procedures assume that the user has previously set up the system and created and opened a QAManager object. It should be noted that sending a message from an application does not ensure it is delivered from the device on which the application is running. Rather, it simply places the message on a queue to be delivered. The QAnywhere Agent carries out the task of sending the message to the MobiLink synchronization server, which in turn delivers it to its destination.

The process starts with the creation of a new message as either a text message or a binary message. A sample method for creating a text message is as follows:

1: QATextMessage * msg;
2: msg = mgr->createTextMessage( );

Next, the message properties are set. Methods of a QATextMessage or a QABinaryMessage class may be used to set properties. After the message has been created, it is put on the queue, ready for sending as follows:

1: if( msg != NULL ) {
2: if( !mgr->putMessage( “store-id\\queue-name”, msg ) )
3: {
4: // display error using mgr->getLastErrorMsg( )
5: }
6: mgr->deleteMessage( msg );
7: }

The above illustrates a simple routine for placing a message on the queue. Note that store-id and queue-name are strings that combine to form the destination address. The process of sending a message by the QAnywhere agent and synchronization client are described above.

Transactional messaging provides the ability to group messages in a way that guarantees that either all messages in the group are delivered, or none are. This is more commonly referred to as a single transaction. When implementing transactional messaging, a special QAManager object called a transactional manager is created. The following describes the steps for creating a transactional manager. First, QAnywhere is initialized in the same manner as with non-transactional messaging as follows:

1: #include <qa.hpp>
2: QAManagerFactory * factory;
3:
4: factory = QAnywhereFactory_init( );
5: if( factory == NULL ) {
6: // fatal error
7: }

Next, a transactional manager is created as follows:

1: QATransactionalManager * mgr;
2:
3: mgr = factory->createQATransactionalManager( NULL );
4: if( mgr == NULL ) {
5: // fatal error
6: }

As with non-transactional managers, a properties file can be specified to customize QAnywhere behavior. In this example, no properties file is used. After the transactional manager is created, it is initialized as follows:

1: if( !mgr->open( ) ) {
2: // display message using mgr->getLastErrorMsg( );
3: }

The system is now ready to send messages. The following procedure sends two messages in a single transaction. First, the message objects are initialized:

1: QATextMessage * msg_1;
2: QATextMessage * msg_2;

The following code illustrates two messages sent in a single transaction:

| | |
|---|---|
| 1: | msg_1 = mgr->createTextMessage( ); |
| 2: | if( msg_1 != NULL ) |
| 3: | { |
| 4: | msg_2 = mgr->createTextMessage( ); |
| 5: | if( msg_2 != NULL ) |
| 6: | { |
| 7: | if( !mgr->putMessage( “jms_1\\queue_name”, msg_1 ) ) |
| 8: | { |
| 9: | // display message using mgr->getLastErrorMsg( ); |
| 10: | } else { |
| 11: | if( !mgr->putMessage( “jms_1\\queue_name”, msg_2 ) ) |
| 12: | { |
| 13: | // display message using mgr->getLastErrorMsg( ); |
| 14: | } else { |
| 15: | mgr->commit( ); |
| 16: | } |
| 17: | } |
| 18: | mgr->deleteMessage( msg_2 ); |
| 19: | } |
| 20: | mgr->deleteMessage( msg_1 ); |
| 21: | } |

The call to the commits method shown above at line 15 commits the messages to the message store. The messages sent to the message store are actually sent during a synchronization session. As described above, the messages are uploaded from a client to the consolidated server during a synchronization session. Messages may also be downloaded from the server to the client during the synchronization. As previously discussed, a synchronization typically includes a bidirectional data exchange between the MobiLink client and synchronization server.

Receipt of Messages by Receiving QAnywhere Client

Messages may be received by a QAnywhere application from a queue maintained in a local message store synchronously or asynchronously. To receive messages synchronously, an application can explicitly poll the queue for messages. It may poll the queue periodically, or when a user initiates a particular action such as clicking a refresh button. The following illustrates sample code for receiving messages synchronously. First, message objects are declared to hold the incoming messages:

1: QAMessage * msg;
2: QATextMessage * text_msg;

The message queue is then polled to receive messages:

| | |
|---|---|
| 1: | if( mgr->start( ) ) { |
| 2: | for( ;; ) { |
| 3: | msg = mgr->getMessageNoWait( “queue_name” ); |
| 4: | if( msg == NULL ) break; |
| 5: | text_msg = msg->castToTextMessage( ); |
| 6: | if( text_msg != NULL ) { |
| 7: | // display text message using |
| 8: | // text_msg->getText( ) |
| 9: | } |
| 10: | sleep( time-period ); |
| 11: | } |
| 12: | mgr->stop( ); |
| 13: | } |

To receive messages asynchronously a user can write and register a message listener function that is called by QAnywhere when a message appears in the queue. The message listener takes the incoming message as a parameter. The task that is performed in the message listener depends on the particular application that is involved. The following illustrates sample code for receiving messages asynchronously. Initially, a class that implements the QAMessageListener interface is created as follows:

1: class MyClass: public QAMessageListener
2: {
3: rivate:
4: void onMessage( QAMessage * Msg);
5: };

The onMessage method is then implemented to process the message, as desired. The QAMessageListener interface contains one method, onMessage. Each time a message arrives in the queue, the QAnywhere library calls this method, passing the new message as the single argument as illustrated by the following:

1: void MyClass::onMessage(QAMessage * msg)
2: {
3: // process msg
4: }

The message listener is then registered as follows:

1: my_listener = new MyClass( );
2: mgr->setMessageListener( “queue-name”, my_listener );

Currently, notifications and network status changes are both sent to QAnywhere applications as system messages. System messages are exactly the same as other messages, but are received in a separate queue named “system”. For example, the following C# code deals with system and normal messages. It assumes that a user has defined the message handling functions onMessage and onSystemMessage that implement the application logic for processing the messages.

1: // Declare the message listener and system listener
2: private QAManager.MessageListener _receiveListener;
3: private QAManager.MessageListener _systemListener;
4: ...
5:
6: // Create a MessageListener that uses the appropriate message handlers
7: _receiveListener = new QAManager.MessageListener( onMessage );
8: _systemListener = new
QAManager.MessageListener( onSystemMessage );
9: ...
10:
11: // Register the message handler
12: mgr.SetMessageListener( queue-name, _receiveListener );
13: mgr.SetMessageListener( “system”, _systemListener );

The system message handler may query the message properties to identify what information a message contains. The message type property indicates if the message holds a network status notification. For example, for a message msg:

1: if( msg.PropertyExists(MessageProperties.MSG_TYPE) ) {
2: msg_type=(MessageType)msg.GetIntProperty(...);
3: ...
4: } else {
5: // Process regular message
6: }msg_type = (MessageType)msg.GetIntProperty(
MessageProperties.MSG_TYPE );
7: if( msg_type ==
MessageType.NETWORK_STATUS_NOTIFICATION ) {
8: // Process a network status change
9: } else if ( msg_type == MessageType.PUSH_NOTIFICATION ) {
10: // Process a push notification
11: } else if ( msg_type == MessageType.REGULAR ) {
12: // This message type should not be received on the system
13: // queue. Take appropriate action here.
14: }

The QAnywhere application receiving the message may then take action based on the message. It may in turn generate messages for delivery to the central server and/or to one or more other mobile devices.

QAnywhere API

The following briefly describes classes of the QAnywhere C++ API. The API provides functionality for development of QAnywhere enabled client applications, putting messages into queues in the message store on a client device, and retrieving messages from queues. The QAnywhere system also currently supports a similar .NET API. The classes of the QAnywhere C++ API include the following:

Class AcknowledgementMode: The acknowledgement modes supported by QAnywhere are transactional, implicit and explicit. The client application specifies the acknowledgement mode when creating its instance of the Class QAManager.

Class MessageProperties: This class defines constant values for useful message property names for sending messages to QAnywhere Server.

Class MessageType: This class defines constant values for the message property “ias_MessageType”.

Class QABinaryMessage: An QABinaryMessage object is used to send a message containing a stream of uninterpreted bytes. It inherits from the Class QAMessage class and adds a bytes message body. The receiver of the message supplies the interpretation of the bytes. When the message is first created, the body of the message is in write-only mode. After the first call to reset has been made, the message body is in read-only mode. After a message has been sent, the client that sent it can retain and modify it without affecting the message that has been sent. The same message object can be sent multiple times. When a message has been received, the provider has called reset so that the message body is in read-only mode for the client. If a client attempts to write a message in read-only mode, a COMMON_MSG_NOT_WRITEABLE_ERROR is set.

Class QAError: This class defines error constants associated with the QAnywhere client. A QAError object is used internally by the Class QAManager object to keep track of errors associated with messaging operations. An application programmer should not need to create an instance of this class. The error constants can be used by an application programmer when interpreting error codes returned by getLastError Function.

Class QAManager: This class is the manager for non-transactional messaging. It is derived from the QAManagerBase class described below.

Class QAManagerBase: This class acts as a base class for Class QATransactionalManager and Class QAManager, which manage transactional and non-transactional messaging respectively. There should be a single instance of QAManagerBase per thread in the application. This class is also a factory for creating messages. Since the getMessage Function methods also create messages, this class manages all messages, so that they can be released from memory either at a user method call, or when the QAManagerBase is closed. The publishMessage Function methods will always return false, since the publish/subscribe model is not supported.

Class QAManagerFactory: This class acts as a factory class for creating Class QATransactionalManager and Class QAManager objects.

Class QAMessage: The QAMessage interface is the root interface of all QAnywhere client messages. The QABinaryMessage and QATextMessage classes are derived from this class.

Class QAMessageListener: A QAMessageListener object is used to receive asynchronously delivered messages.

Class QATextMessage: A QATextMessage object is used to send a message containing an qa_string. It inherits from the Class QAMessage class and adds a text message body. When a client receives an QATextMessage, it is in read-only mode. If a client attempts to write to the message at this point, a COMMON_MSG_NOT_WRITEABLE_ERROR is set.

Class QATransactionalManager: This class is the manager for transactional messaging.

While the invention is described in some detail with specific reference to a single-preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A system for messaging between applications, the system comprising:
a database at a mobile device for receiving a message from an application at the mobile device for transmission to a particular application at another device;
an agent at the mobile device for sending the message to a server by synchronizing the database at the mobile device with a consolidated database at the server;
a consolidated database at the server for storing the message received from the mobile device; and
a module at the server for providing the message to the particular application.

2. The system of claim 1, wherein the agent at the mobile device sends the message to the server using a data synchronization protocol.

3. The system of claim 1, wherein the particular application is running at the server.

4. The system of claim 1, wherein the particular application is running at a second mobile device.

5. The system of claim 4, wherein said module at the server provides the message to the second mobile device by synchronizing the consolidated database with a database at the second mobile device.

6. The system of claim 4, further comprising:
a module at the second mobile device for receiving the message from the server and providing it to the particular application at the second mobile device.

7. The system of claim 1, wherein the agent at the mobile device determines whether to send the message to the server based on transmission rules specifying when particular messages are to be transmitted.

8. The system of claim 7, wherein said transmission rules comprise user specified rules for message transmission.

9. The system of claim 7, wherein said agent determines whether to send the message based, at least in part, on type of connection available between the mobile device and the server.

10. The system of claim 7, wherein said transmission rules include rules specifying whether to send the message based on properties of the message.

11. The system of claim 10, wherein said properties of the message include one or more of size of the message, address of the message, and priority level of the message.

12. The system of claim 1, further comprising:
a transmission rules engine for determining whether to send the message during a particular synchronization session between the mobile device and the server.

13. The system of claim 12, wherein said transmission rules engine determines whether to send the message based upon properties of the message.

14. The system of claim 12, wherein said transmission rules engine determines whether to send the message based, at least in part, upon current type of network connection between the mobile device and the server.

15. The system of claim 1, wherein said module at the server determines when to transmit the message to the particular application based on transmission rules applicable at the server.

16. The system of claim 15, wherein said module at the server determines whether to transmit the message to a second mobile device based, at least in part, upon information uploaded from the second mobile device to the server during a synchronization session between the second mobile device and the server.

17. The system of claim 1, further comprising:
a tracking module at the mobile device for tracking changes in network connectivity at the mobile device.

18. The system of claim 17, wherein said tracking module notifies the server of changes in network address of the mobile device.

19. The system of claim 1, further comprising:
a notification module at the server for notifying a mobile device that a message is available for the mobile device at the server.

20. A method for messaging between applications where at least some of the applications are running on mobile devices, the method comprising:
receiving a message from an application at a mobile device for transmission to a particular application at another device;
storing the message in a database at the mobile device;
synchronizing the database at the mobile device with a consolidated database at a server when the mobile device establishes connectivity with the server, so as to transmit the message from the mobile device to the server; and
providing the message in the consolidated database at the server to the particular application.

21. The method of claim 20, wherein said synchronizing step includes synchronizing the database at the mobile device with the consolidated database using a data synchronization protocol.

22. The method of claim 20, wherein said particular application is running at the server.

23. The method of claim 20, wherein said particular application is running at a second mobile device.

24. The method of claim 23, wherein said providing step includes providing the message to the second mobile device by synchronizing the consolidated database with a database at the second mobile device.

25. The method of claim 20, further comprising:
determining whether to send the message when the mobile device synchronizes with the server based on transmission rules specifying when particular messages are to be transmitted.

26. The method of claim 25, wherein said transmission rules comprise user specified rules for message transmission.

27. The method of claim 25, wherein said transmission rules include a rule based on type of connection available between the mobile device and the server.

28. The method of claim 27, wherein said transmission rules include a rule based on properties of the message.

29. The method of claim 28, wherein said properties of the message include one or more of size of the message and priority level of the message.

30. The method of claim 22, wherein said providing step includes determining whether to transmit the message to a second mobile device based on transmission rules applicable to the server.

31. The method of claim 30, wherein said determining step includes determining whether to transmit the message based, at least in part, upon information uploaded from the second mobile device to the server.

32. The method of claim 22, further comprising:
tracking changes in network connectivity at the mobile device and notifying the server of changes in network address of the mobile device.

33. A computer-readable medium having processor-executable instructions for performing the method of claim 22.

34. A downloadable set of processor-executable instructions for performing the method of claim 22.

35. In a messaging system comprising a plurality of devices exchanging messages, a method for regulating message transmission based on specified rules, the method comprising:
receiving rules specifying when messages are to be transmitted by at least some of said plurality of devices;
determining whether transmission of a message received at a particular device for transmission to another device is permitted under the rules;
transmitting the message if transmission is permitted under the rules; and
otherwise, delaying transmission of the message until transmission of the message is permitted under the rules.

36. The method of claim 35, wherein said rules comprise user specified rules for message transmission.

37. The method of claim 35, wherein said rules include a rule based, at least in part, on type of network connection in use at the particular device.

38. The method of claim 37, wherein said type of network connection includes a selected one of a wireless connection and a wireline connection.

39. The method of claim 35, wherein said rules include a rule based, at least in part, on one or more of day, time of day, and time elapsed since previous message transmission at the particular device.

40. The method of claim 35, further comprising:
detecting changes in connectivity between the particular device and another device; and
determining whether transmission of the message is permitted under the rules if a change in connectivity is detected.

41. The method of claim 35, wherein said rules include a rule specifying whether to send the message based on properties of the message.

42. The method of claim 41, wherein said properties of the message include one or more of size of the message, address of the message, and priority level assigned to the message.

43. The method of claim 35, said determining step includes determining whether to send a message received at a mobile device to a server during synchronization of the mobile device with the server.

44. The method of claim 35, wherein said determining step includes determining whether to send a message stored at a server to a mobile device during synchronization of the mobile device with the server.

45. The method of claim 35, wherein said receiving step includes receiving user input specifying rules applicable to one or more devices.

46. The method of claim 35, wherein said determining step includes determining whether to transmit the message when the particular device establishes connectivity with another device for transmission of messages.
